(19) United States
(12) Patent Application Publication
(10) Pub. No.: US 2025/0113350 A1
(43) Pub. Date: Apr. 3, 2025

(54) COMMUNICATION METHOD AND APPARATUS

(71) Applicant: HUAWEI TECHNOLOGIES CO., LTD., Shenzhen (CN)

(72) Inventors: Dongdong WEI, Shenzhen (CN); Yongxia LYU, Shenzhen (CN); Ting WANG, Shanghai (CN)

(21) Appl. No.: 18/979,800

(22) Filed: Dec. 13, 2024

Related U.S. Application Data
(63) Continuation of application No. PCT/CN2023/099644, filed on Jun. 12, 2023.

(30) Foreign Application Priority Data
Jun. 16, 2022 (CN) 202210680022.1

(51) Int. Cl. H04W 72/1263; H04W 76/27

(52) U.S. Cl. CPC H04W 72/1263; H04W 76/27

(57) ABSTRACT

This application provides a communication method and a communication apparatus. In the method, a terminal device obtains first information, where the first information is associated with a mode of communication between a first network device and the terminal device and/or a mode of communication between a second network device and the terminal device, and the communication mode includes any one of the following: whether uplink transmission is activated, or whether downlink transmission is activated; and the terminal device determines to communicate with the first network device and/or the second network device based on the first information. In other words, in a network device, an uplink transmission module configured to receive an uplink signal is disabled, or a downlink transmission module configured to send a downlink signal is disabled.

### CROSS-REFERENCE TO RELATED APPLICATIONS

This application is a continuation of International Application No. PCT/CN2023/099644, filed on Jun. 12, 2023, which claims priority to Chinese Patent Application No. 202210680022.1, filed on Jun. 16, 2022. The disclosures of the aforementioned applications are hereby incorporated by reference in their entireties.

### TECHNICAL FIELD

This application relates to the field of wireless technologies, and in particular, to a communication method and a device.

### BACKGROUND

To meet increasing traffic requirements of people, wireless networks are being rapidly constructed. As a network scale becomes larger, and a large-scale antenna and a transceiver module that supports a high-frequency signal are deployed, network energy consumption continuously increases. Therefore, to save energy, reduce emission, and reduce electricity expenses, reducing energy consumption of a network device is one of important requirements of a communication system. How to reduce energy consumption of the network device is an urgent technical problem to be resolved.

### SUMMARY

This application provides a communication method and a communication apparatus, to reduce energy consumption of a network device.

A first aspect of this application provides a communication method. The method is performed by a terminal device, or the method is performed by some components (for example, a processor, a chip, or a chip system) in the terminal device, or the method may be implemented by a logical module or software that can implement all or some functions of the terminal device. In the first aspect and possible implementations thereof, an example in which the communication method is performed by the terminal device is used for description. In the method, the terminal device obtains first information, where the first information is associated with a mode of communication between a first network device and the terminal device and/or a mode of communication between a second network device and the terminal device, and the communication mode includes any one of the following: whether uplink transmission is activated, or whether downlink transmission is activated; and the terminal device communicates with the first network device and/or the second network device based on the first information.

Based on the foregoing technical solution, the terminal device obtains the first information associated with the mode of communication between the first network device and the terminal device and/or the mode of communication between the second network device and the terminal device, and the terminal device communicates with the first network device and/or the second network device based on the first information. In other words, in a network device (including the first network device and/or the second network device), an uplink transmission module configured to receive an uplink signal is disabled, or a downlink transmission module configured to send a downlink signal is disabled, so that control of the uplink and downlink transmission modules in the network device is decoupled, so as to improve flexibility and reduce energy consumption of the network device, thereby reducing operating expenses of the network device.

In addition, the foregoing technical solution can be applied to a communication system in which an uplink transmission module and a downlink transmission module are decoupled from different network devices, for example, a communication system formed by a wide-coverage base station and a small-coverage base station, or a communication system formed by an air base station and a terrestrial station, and can reduce energy consumption of the network devices in this scenario.

Optionally, in the communication system in which the uplink transmission module and the downlink transmission module are decoupled from different network devices, the terminal device may perform uplink communication with a network device that is closer to the terminal device, and a communication mode of the network device accessed by the terminal device is an implementation in which uplink transmission is activated and downlink transmission is deactivated. Because the uplink transmission module in the network device remains in an activated state, the terminal device does not need to increase transmit power, thereby avoiding an increase in energy consumption of the terminal device.

The foregoing technical solution can be applied to a scenario in which a network device has an uplink transmission module but does not have a downlink transmission module (or a network device has a downlink transmission module but does not have an uplink transmission module).

It should be understood that, in this application, “activate” may be replaced with “open”, “enable”, “start”, or the like. Correspondingly, “deactivate” may be replaced with “close”, “off”, “sleep”, “mute”, “prohibit”, “disable”, or the like.

In a possible implementation of the first aspect, the communication mode includes at least one of the following: uplink transmission is activated and downlink transmission is deactivated, uplink transmission is deactivated and downlink transmission is activated, uplink transmission is activated, uplink transmission is deactivated, downlink transmission is activated, downlink transmission is deactivated, uplink transmission is activated and downlink transmission is activated, or uplink transmission is deactivated and downlink transmission is deactivated.

Based on the foregoing technical solution, a communication mode that is of a network device (including the first network device and/or the second network device) and that is associated with the first information may include any one of the foregoing communication modes, so that the network device controls uplink transmission and downlink transmission more flexibly.

It should be understood that both the communication mode in which uplink transmission is activated and the communication mode in which uplink transmission is activated and downlink transmission is deactivated may indicate that an uplink transmission module in the network device is activated, both the communication mode in which uplink transmission is deactivated and the communication mode in which uplink transmission is deactivated and downlink transmission is activated may indicate that the uplink transmission module in the network device is deactivated, both the communication mode in which downlink transmission is activated and the communication mode in which uplink transmission is deactivated and downlink transmission is activated may indicate that a downlink transmission module in the network device is activated, and both the communication mode in which downlink transmission is deactivated and the communication mode in which uplink transmission is activated and downlink transmission is deactivated may indicate that the downlink transmission module in the network device is deactivated.

Optionally, in a plurality of implementations of the foregoing communication modes, different implementations indicating a same communication mode may be flexibly applied to different scenarios. For example, both the communication mode in which uplink transmission is activated and the communication mode in which uplink transmission is activated and downlink transmission is deactivated may indicate an implementation process of activating uplink transmission of the network device. When the network device has an uplink transmission module but does not have a downlink transmission module, the mode that is for communicating with the network device and that is determined by the terminal device is that uplink transmission is activated. When the network device has an uplink transmission module but does not have a downlink transmission module, the mode that is for communicating with the network device and that is determined by the terminal device is that uplink transmission is activated, or the mode that is for communicating with the network device and that is determined by the terminal device is that uplink transmission is activated and downlink transmission is deactivated.

In a possible implementation of the first aspect, the first information is included in any one of the following: a radio resource control (radio resource control, RRC) reconfiguration message or an RRC release message.

Based on the foregoing technical solution, when the terminal device is in an RRC connected state, the terminal device may obtain the first information by using an RRC connection to the network device. The first information may be carried in an RRC message (for example, the RRC reconfiguration message or the RRC release message), so that the terminal device obtains the first information based on the RRC message and determines to communicate with the first network device and/or the second network device based on the first information.

In a possible implementation of the first aspect,
the first information indicates a communication mode corresponding to one or more cells, and the one or more cells include a cell of the first network device and/or a cell of the second network device;
the first information indicates a communication mode of a network device corresponding to one or more synchronization signal block (synchronization signal/physical broadcast channel block, SS/PBCH block, SS/PBCH block, or SSB) identifiers, and the network device corresponding to the one or more SSB identifiers includes the first network device and/or the second network device; or
the first information indicates a communication mode of a network device in one or more areas corresponding to one or more area identifiers, and the network device in the one or more areas corresponding to the one or more area identifiers includes the first network device and/or the second network device.

Optionally, the first information is included in a system information block (system information block, SIB).

Further, optionally, when the first information is included in the SIB, the SIB includes at least one of the following:
a first cell list, where a cell indicated by the first cell list includes a cell corresponding to the first network device and/or a cell corresponding to the second network device;
one or more SSB identifiers, where a network device corresponding to the one or more SSB identifiers includes the first network device and/or the second network device; or
one or more area identifiers, where a network device in one or more areas indicated by the one or more area identifiers includes the first network device and/or the second network device.

Based on the foregoing technical solution, when the terminal device is in an idle mode, the terminal device may obtain the first information by receiving/detecting a broadcast message. The first information may indicate the communication mode of the network device (including the first network device and/or the second network device) by using the cell-related information, the SSB identifier-related information, the area-related information, or the like, so that the terminal device communicates with the first network device and/or the second network device based on the first information.

In a possible implementation of the first aspect, the first information is associated with the mode of communication between the first network device and the terminal device, where the first information includes at least one of the following:
indication information indicating that uplink configuration information between the terminal device and the first network device remains unchanged;
information about association between an uplink data radio bearer (data radio bearer, DRB) and a downlink DRB of the terminal device;
encrypted information of downlink transmission between the terminal device and the first network device; or
indication information indicating the communication mode of the first network device.

Based on the foregoing technical solution, when uplink transmission between the terminal device and the first network device does not change and downlink transmission of the first network device changes (for example, downlink transmission activated is changed to downlink transmission deactivated, or downlink transmission deactivated is changed to downlink transmission activated), the terminal device may further communicate with the first network device based on the at least one piece of information included in the first information.

Optionally, when the first information is associated with the mode of communication between the first network device and the terminal device, the first information may further include at least one of the following:
indication information indicating that downlink configuration information between the terminal device and the first network device remains unchanged; or
indication information indicating that encrypted information of uplink transmission between the terminal device and the first network device is the same as encrypted information of downlink transmission.

Based on the foregoing technical solution, when downlink transmission between the terminal device and the first network device does not change and uplink transmission of the first network device changes (for example, uplink transmission activated is changed to uplink transmission deactivated, or uplink transmission deactivated is changed to uplink transmission activated), the terminal device may further communicate with the first network device based on the at least one piece of information included in the first information.

A second aspect of this application provides a communication method. The method is performed by a network device, or the method is performed by some components (for example, a processor, a chip, or a chip system) in the network device, or the method may be implemented by a logical module or software that can implement all or some functions of the network device. In the second aspect and possible implementations thereof, an example in which the communication method is performed by a first network device is used for description. In the method, the first network device obtains first indication information, where the first indication information indicates a mode of communication between the first network device and a terminal device and/or a mode of communication between a second network device and the terminal device, and the communication mode includes any one of the following: whether uplink transmission is activated, or whether downlink transmission is activated; and the first network device determines the communication mode based on the first indication information.

Based on the foregoing technical solution, the first network device obtains the first indication information indicating the mode of communication between the first network device and the terminal device and/or the mode of communication between the second network device and the terminal device, and the first network device determines, based on the first indication information, that the communication mode is that uplink transmission is activated or uplink transmission is deactivated, or the first network device determines, based on the first indication information, that the communication mode is that downlink transmission is activated or downlink transmission is deactivated. In other words, in a network device (including the first network device and/or the second network device), an uplink transmission module configured to receive an uplink signal is disabled, or a downlink transmission module configured to send a downlink signal is disabled, so that control of the uplink and downlink transmission modules in the network device is decoupled, so as to improve flexibility and reduce energy consumption of the network device, thereby reducing operating expenses of the network device.

In addition, compared with an implementation in which an uplink transmission module and a downlink transmission module in a same network device are simultaneously disabled to reduce energy consumption of the network device, the foregoing technical solution does not need to limit simultaneous disabling of the uplink transmission module and the downlink transmission module in the same network device. In other words, the foregoing technical solution can be applied to a communication system in which an uplink transmission module and a downlink transmission module are decoupled from different network devices, for example, a communication system formed by a wide-coverage base station and a small-coverage base station, or a communication system formed by an air base station and a terrestrial station, and can reduce energy consumption of the network devices in this scenario.

In addition, compared with the implementation in which an uplink transmission module and a downlink transmission module in a same network device are simultaneously disabled to reduce energy consumption of the network device, because the foregoing technical solution does not need to limit a case in which the network device has both the uplink transmission module and the downlink transmission module, the foregoing technical solution can be applied to a scenario in which the network device has the uplink transmission module but does not have the downlink transmission module (or the network device has the downlink transmission module but does not have the uplink transmission module).

Optionally, in the communication system in which the uplink transmission module and the downlink transmission module are decoupled from different network devices, the terminal device may perform uplink communication with a network device that is closer to the terminal device, and a communication mode of the network device accessed by the terminal device is an implementation in which uplink transmission is activated and downlink transmission is deactivated. Because the uplink transmission module in the network device remains in an activated state, the terminal device does not need to increase transmit power, thereby avoiding an increase in energy consumption of the terminal device.

In a possible implementation of the second aspect, the communication mode includes at least one of the following: uplink transmission is activated and downlink transmission is deactivated, uplink transmission is deactivated and downlink transmission is activated, uplink transmission is activated, uplink transmission is deactivated, downlink transmission is activated, downlink transmission is deactivated, uplink transmission is activated and downlink transmission is activated, or uplink transmission is deactivated and downlink transmission is deactivated.

Based on the foregoing technical solution, a communication mode that is of a network device (including the first network device and/or the second network device) and that is indicated by the first indication information obtained by the first network device may further include any one of the foregoing communication modes, so that the network device controls uplink transmission and downlink transmission more flexibly.

It should be understood that both the communication mode in which uplink transmission is activated and the communication mode in which uplink transmission is activated and downlink transmission is deactivated may indicate that an uplink transmission module in the network device is activated, both the communication mode in which uplink transmission is deactivated and the communication mode in which uplink transmission is deactivated and downlink transmission is activated may indicate that the uplink transmission module in the network device is deactivated, both the communication mode in which downlink transmission is activated and the communication mode in which uplink transmission is deactivated and downlink transmission is activated may indicate that a downlink transmission module in the network device is activated, and both the communication mode in which downlink transmission is deactivated and the communication mode in which uplink transmission is activated and downlink transmission is deactivated may indicate that the downlink transmission module in the network device is deactivated.

Optionally, in a plurality of implementations of the foregoing communication modes, different implementations indicating a same communication mode may be flexibly applied to different scenarios. For example, both the communication mode in which uplink transmission is activated and the communication mode in which uplink transmission is activated and downlink transmission is deactivated may indicate an implementation process of activating uplink transmission of the network device. When the network device has an uplink transmission module but does not have a downlink transmission module, the mode that is for communicating with the network device and that is determined by the terminal device is that uplink transmission is activated. When the network device has an uplink transmission module but does not have a downlink transmission module, the mode that is for communicating with the network device and that is determined by the terminal device is that uplink transmission is activated, or the mode that is for communicating with the network device and that is determined by the terminal device is that uplink transmission is activated and downlink transmission is deactivated.

In a possible implementation of the second aspect, the method further includes: The first network device sends first information, where the first information is associated with the communication mode.

Based on the foregoing technical solution, after the first network device determines the communication mode, the first network device may further send, to the terminal device, the first information associated with the communication mode, so that the terminal device communicates with the first network device and/or the second network device based on the first information.

In a possible implementation of the second aspect, the first information is included in any one of the following: an RRC reconfiguration message or an RRC release message.

Based on the foregoing technical solution, when the terminal device is in an RRC connected state, the terminal device may obtain the first information by using an RRC connection to the network device. The first information may be carried in an RRC message (for example, the RRC reconfiguration message or the RRC release message), so that the terminal device obtains the first information based on the RRC message and communicates with the first network device and/or the second network device based on the first information.

In a possible implementation of the second aspect, the first information meets at least one of the following:
the first information indicates a communication mode corresponding to one or more cells, and the one or more cells include a cell of the first network device and/or a cell of the second network device;
the first information indicates a communication mode of a network device corresponding to one or more SSB identifiers, and the network device corresponding to the one or more SSB identifiers includes the first network device and/or the second network device; or
the first information indicates a communication mode of a network device in one or more areas corresponding to one or more area identifiers, and the network device in the one or more areas corresponding to the one or more area identifiers includes the first network device and/or the second network device.

Optionally, the first information is included in a SIB.

Further, optionally, when the first information is included in the SIB, the SIB includes at least one of the following:
a first cell list, where a cell indicated by the first cell list includes a cell corresponding to the first network device and/or a cell corresponding to the second network device;
one or more SSB identifiers, where a network device corresponding to the one or more SSB identifiers includes the first network device and/or the second network device; or
one or more area identifiers, where a network device in one or more areas indicated by the one or more area identifiers includes the first network device and/or the second network device.

Based on the foregoing technical solution, when the terminal device is in an idle mode, the terminal device may obtain the first information by receiving/detecting a broadcast message. The first information may indicate the communication mode of the network device (including the first network device and/or the second network device) by using the cell-related information, the SSB identifier-related information, the area-related information, or the like, so that the terminal device communicates with the first network device and/or the second network device based on the first information.

In a possible implementation of the second aspect, the first indication information indicates the mode of communication between the first network device and the terminal device, where the first information includes at least one of the following:
indication information indicating that uplink configuration information between the terminal device and the first network device remains unchanged;
information about association between an uplink DRB and a downlink DRB of the terminal device;
encrypted information of downlink transmission between the terminal device and the first network device; or
indication information indicating the communication mode of the first network device.

Based on the foregoing technical solution, when uplink transmission between the terminal device and the first network device does not change and downlink transmission of the first network device changes (for example, downlink transmission activated is changed to downlink transmission deactivated, or downlink transmission deactivated is changed to downlink transmission activated), the terminal device may further communicate with the first network device based on the at least one piece of information included in the first information.

Optionally, when the first information is associated with the mode of communication between the first network device and the terminal device, the first information may further include at least one of the following:
indication information indicating that downlink configuration information between the terminal device and the first network device remains unchanged; or
indication information indicating that encrypted information of uplink transmission between the terminal device and the first network device is the same as encrypted information of downlink transmission.

Based on the foregoing technical solution, when downlink transmission between the terminal device and the first network device does not change and uplink transmission of the first network device changes (for example, uplink transmission activated is changed to uplink transmission deactivated, or uplink transmission deactivated is changed to uplink transmission activated), the terminal device may further communicate with the first network device based on the at least one piece of information included in the first information.

In a possible implementation of the second aspect, the first indication information indicates the mode of communication between the first network device and the terminal device; and that a first network device obtains the first indication information includes: The first network device receives the first indication information.

Based on the foregoing technical solution, when the first indication information indicates the mode of communication between the first network device and the terminal device, the first network device may obtain the first indication information by receiving the first indication information, so that the first network device serves as a controlled network device, and another device serves as a control device, to control energy consumption of the first network device.

It should be noted that the first indication information may be from another network device different from the first network device, a network node, a network element, or a network management device. This is not limited herein.

Optionally, the network management device may be an operation, administration and maintenance (operation, administration and maintenance, OAM) device, an operations support system (operations support system, OSS), or another device. This is not limited herein.

In a possible implementation of the second aspect, the method further includes: The first network device updates the communication mode of the first network device based on the first indication information.

Based on the foregoing technical solution, in an implementation process in which the first network device obtains the first indication information by receiving the first indication information, the first network device may further locally update the communication mode of the first network device based on the first indication information, so that the first network device disables an uplink transmission module configured to receive an uplink signal or disables a downlink transmission module configured to send a downlink signal, thereby reducing energy consumption of the first network device.

In a possible implementation of the second aspect, the first indication information indicates the mode of communication between the second network device and the terminal device; and that a first network device obtains the first indication information includes: The first network device determines the first indication information. The method further includes: The first network device sends the first indication information to the second network device.

Based on the foregoing technical solution, when the first indication information indicates the mode of communication between the second network device and the terminal device, the first network device sends the first indication information to the second network device after determining the first indication information. Therefore, the second network device serves as a controlled network device, and the first network device serves as a control device, to control energy consumption of the second network device, thereby reducing energy consumption of the second network device.

In a possible implementation of the second aspect, the first indication information is included in any one of the following: a radio access network RAN node configuration update (RAN NODE CONFIGURATION UPDATE) message, a disable request reply message, a disable request reject message, and a cell activation request (CELL ACTIVATION REQUEST) message.

Based on the foregoing technical solution, the first indication information may be carried in any one of the foregoing messages, so that the first network device and/or the second network device receive/receives the first indication information based on any one of the foregoing messages from another network device, and energy consumption is reduced based on the first indication information.

A third aspect of this application provides a communication apparatus. The apparatus may implement the method according to any one of the first aspect or the possible implementations of the first aspect. The apparatus includes a corresponding unit or module configured to perform the foregoing method. The unit or module included in the apparatus can be implemented by using software and/or hardware. For example, the apparatus may be a terminal device, or the apparatus may be a component (for example, a processor, a chip, or a chip system) in the terminal device, or the apparatus may be a logical module or software that can implement all or some functions of the terminal device.

The apparatus includes a processing unit and a transceiver unit. The transceiver unit is configured to obtain first information, where the first information is associated with a mode of communication between a first network device and the terminal device and/or a mode of communication between a second network device and the terminal device, and the communication mode includes any one of the following: whether uplink transmission is activated, or whether downlink transmission is activated; and the processing unit is configured to communicate with the first network device and/or the second network device based on the first information.

In a possible implementation of the third aspect, the communication mode includes at least one of the following: uplink transmission is activated and downlink transmission is deactivated, uplink transmission is deactivated and downlink transmission is activated, uplink transmission is activated, uplink transmission is deactivated, downlink transmission is activated, downlink transmission is deactivated, uplink transmission is activated and downlink transmission is activated, or uplink transmission is deactivated and downlink transmission is deactivated.

In a possible implementation of the third aspect, the first information is included in any one of the following: a radio resource control RRC reconfiguration message or an RRC release message.

In a possible implementation of the third aspect, the first information meets at least one of the following:
the first information indicates a communication mode corresponding to one or more cells, and the one or more cells include a cell of the first network device and/or a cell of the second network device;
the first information indicates a communication mode of a network device corresponding to one or more SSB identifiers, and the network device corresponding to the one or more SSB identifiers includes the first network device and/or the second network device; or
the first information indicates a communication mode of a network device in one or more areas corresponding to one or more area identifiers, and the network device in the one or more areas corresponding to the one or more area identifiers includes the first network device and/or the second network device.

Optionally, the first information is included in a SIB.

Further, optionally, when the first information is included in the SIB, the SIB includes at least one of the following:
a first cell list, where a cell indicated by the first cell list includes a cell corresponding to the first network device and/or a cell corresponding to the second network device;
one or more SSB identifiers, where a network device corresponding to the one or more SSB identifiers includes the first network device and/or the second network device; or
one or more area identifiers, where a network device in one or more areas indicated by the one or more area identifiers includes the first network device and/or the second network device.

In a possible implementation of the third aspect, the first information is associated with the mode of communication between the first network device and the terminal device, where the first information includes at least one of the following:
indication information indicating that uplink configuration information between the terminal device and the first network device remains unchanged;
information about association between an uplink data radio bearer DRB and a downlink DRB of the terminal device;
encrypted information of downlink transmission between the terminal device and the first network device; or
indication information indicating the communication mode of the first network device.

Optionally, when the first information is associated with the mode of communication between the first network device and the terminal device, the first information may further include at least one of the following:
indication information indicating that downlink configuration information between the terminal device and the first network device remains unchanged; or
indication information indicating that encrypted information of uplink transmission between the terminal device and the first network device is the same as encrypted information of downlink transmission.

In the third aspect of embodiments of this application, the composition modules of the communication apparatus may be further configured to perform the steps performed in the possible implementations of the first aspect, and implement corresponding technical effects. For details, refer to the first aspect. Details are not described herein again.

A fourth aspect of this application provides a communication apparatus. The apparatus may implement the method according to any one of the second aspect or the possible implementations of the second aspect. The apparatus includes a corresponding unit or module configured to perform the foregoing method. The unit or module included in the apparatus can be implemented by using software and/or hardware. For example, the apparatus may be a first network device, or the apparatus may be a component (for example, a processor, a chip, or a chip system) in the first network device, or the apparatus may be a logical module or software that can implement all or some functions of the first network device.

The apparatus includes a processing unit. The processing unit is configured to obtain first indication information, where the first indication information indicates a mode of communication between the first network device and a terminal device and/or a mode of communication between a second network device and the terminal device, and the communication mode includes any one of the following: whether uplink transmission is activated, or whether downlink transmission is activated. The processing unit is further configured to determine the communication mode based on the first indication information.

In a possible implementation of the fourth aspect, the communication mode includes at least one of the following:
uplink transmission is activated and downlink transmission is deactivated, uplink transmission is deactivated and downlink transmission is activated, uplink transmission is activated, uplink transmission is deactivated, downlink transmission is activated, downlink transmission is deactivated, uplink transmission is activated and downlink transmission is activated, or uplink transmission is deactivated and downlink transmission is deactivated.

In a possible implementation of the fourth aspect, the apparatus further includes:

The first network device sends first information, where the first information is associated with the communication mode.

In a possible implementation of the fourth aspect, the first information is included in any one of the following:
a radio resource control RRC reconfiguration message or an RRC release message.

In a possible implementation of the fourth aspect,
the first information indicates a communication mode corresponding to one or more cells, and the one or more cells include a cell of the first network device and/or a cell of the second network device;
the first information indicates a communication mode of a network device corresponding to one or more SSB identifiers, and the network device corresponding to the one or more SSB identifiers includes the first network device and/or the second network device; or
the first information indicates a communication mode of a network device in one or more areas corresponding to one or more area identifiers, and the network device in the one or more areas corresponding to the one or more area identifiers includes the first network device and/or the second network device.

Optionally, the first information is included in a SIB.

Further, optionally, when the first information is included in the SIB, the SIB includes at least one of the following:
a first cell list, where a cell indicated by the first cell list includes a cell corresponding to the first network device and/or a cell corresponding to the second network device;
one or more SSB identifiers, where a network device corresponding to the one or more SSB identifiers includes the first network device and/or the second network device; or
one or more area identifiers, where a network device in one or more areas indicated by the one or more area identifiers includes the first network device and/or the second network device.

In a possible implementation of the fourth aspect, the first indication information indicates the mode of communication between the first network device and the terminal device, where the first information includes at least one of the following:
indication information indicating that uplink configuration information between the terminal device and the first network device remains unchanged;
information about association between an uplink data radio bearer DRB and a downlink DRB of the terminal device;
encrypted information of downlink transmission between the terminal device and the first network device; or
indication information indicating the communication mode of the first network device.

In a possible implementation of the fourth aspect, the first indication information indicates the mode of communication between the first network device and the terminal device; and that the processing unit is configured to obtain the first indication information includes: The processing unit is configured to receive the first indication information.

In a possible implementation of the fourth aspect, the processing unit is further configured to update the communication mode of the first network device based on the first indication information.

In a possible implementation of the fourth aspect, the first indication information indicates the mode of communication between the second network device and the terminal device; and that the processing unit is configured to obtain the first indication information includes: The processing unit is configured to determine the first indication information. The apparatus further includes a transceiver unit, and the transceiver unit is configured to send the first indication information to the second network device.

In a possible implementation of the fourth aspect, the first indication information is included in any one of the following: a radio access network RAN node configuration update message, a disable request reply message, a disable request reject message, or a cell activation request message.

In the fourth aspect of embodiments of this application, the composition modules of the communication apparatus may be further configured to perform the steps performed in the possible implementations of the second aspect, and implement corresponding technical effects. For details, refer to the second aspect. Details are not described herein again.

A fifth aspect of embodiments of this application provides a communication apparatus, including at least one processor. The at least one processor is coupled to a memory, the memory is configured to store a program or instructions, and the at least one processor is configured to execute the program or the instructions, so that the apparatus implements the method according to any one of the first aspect or the possible implementations of the first aspect.

A sixth aspect of embodiments of this application provides a communication apparatus, including at least one processor. The at least one processor is coupled to a memory, the memory is configured to store a program or instructions, and the at least one processor is configured to execute the program or the instructions, so that the apparatus implements the method according to any one of the second aspect or the possible implementations of the second aspect.

A seventh aspect of embodiments of this application provides a communication apparatus, including at least one logic circuit and an input/output interface. The logic circuit is configured to perform the method according to any one of the first aspect or the possible implementations of the first aspect.

An eighth aspect of embodiments of this application provides a communication apparatus, including at least one logic circuit and an input/output interface. The logic circuit is configured to perform the method according to any one of the second aspect or the possible implementations of the second aspect.

A ninth aspect of embodiments of this application provides a computer-readable storage medium storing one or more computer-executable instructions. When the computer-executable instructions are executed by a processor, the processor performs the method according to any one of the first aspect or the possible implementations of the first aspect, or the processor performs the method according to any one of the second aspect or the possible implementations of the second aspect.

A tenth aspect of embodiments of this application provides a computer program product (or referred to as a computer program) storing one or more computer-executable instructions. The computer program product includes a program or instructions. When the program or the instructions in the computer program product are executed by a processor, the processor performs the method according to any one of the first aspect or the possible implementations of the first aspect, or the processor performs the method according to any one of the second aspect or the possible implementations of the second aspect.

An eleventh aspect of embodiments of this application provides a chip system. The chip system includes at least one processor, configured to support a communication apparatus in implementing the functions according to any one of the first aspect or the possible implementations of the first aspect, or configured to support a communication apparatus in implementing the functions according to any one of the second aspect or the possible implementations of the second aspect.

In a possible design, the chip system may further include a memory. The memory is configured to store program instructions and data that are necessary for the communication apparatus. The chip system may include a chip, or may include a chip and another discrete component. Optionally, the chip system further includes an interface circuit, and the interface circuit provides program instructions and/or data for the at least one processor.

A twelfth aspect of embodiments of this application provides a communication system. The communication system includes the communication apparatus according to the third aspect and the communication apparatus according to the fourth aspect; and/or the communication system includes the communication apparatus according to the fifth aspect and the communication apparatus according to the sixth aspect; and/or the communication system includes the communication apparatus according to the seventh aspect and the communication apparatus according to the eighth aspect.

For technical effects brought by any design manner of the third aspect to the twelfth aspect, refer to the technical effects brought by different design manners of the first aspect and the second aspect. Details are not described herein.

### BRIEF DESCRIPTION OF DRAWINGS

FIG. 1 is a diagram of a communication system according to this application;

FIG. 2a is another diagram of a communication system according to this application;

FIG. 2b is another diagram of a communication system according to this application;

FIG. 2c is another diagram of a communication system according to this application;

FIG. 2d is another diagram of a communication system according to this application;

FIG. 3a is an interaction diagram of a cell activation/deactivation method;

FIG. 3b is an interaction diagram of another cell activation/deactivation method;

FIG. 3c is another diagram of a communication method according to this application;

FIG. 4 is another diagram of a communication method according to this application;

FIG. 5 is a diagram of an application scenario according to this application;

FIG. 6 is another diagram of a communication method according to this application;

FIG. 7a is another diagram of an application scenario according to this application;

FIG. 7b is another diagram of an application scenario according to this application;

FIG. 8 is a diagram of a communication apparatus according to this application;

FIG. 9 is another diagram of a communication apparatus according to this application;

FIG. 10 is another diagram of a communication apparatus according to this application;

FIG. 11 is another diagram of a communication apparatus according to this application; and

FIG. 12 is another diagram of a communication apparatus according to this application.

### DESCRIPTION OF EMBODIMENTS

The following describes the technical solutions in embodiments of this application with reference to the accompanying drawings in embodiments of this application. All other embodiments obtained by a person of ordinary skill in the art based on embodiments of this application without creative efforts shall fall within the protection scope of this application.

First, some terms in embodiments of this application are explained and described, to facilitate understanding of a person skilled in the art.

(1) Terminal device: The terminal device may be a wireless terminal device that can receive scheduling and indication information from a network device. The wireless terminal device may be a device that provides a user with voice and/or data connectivity, a handheld device having a wireless connection function, or another processing device connected to a wireless modem.

The terminal device may communicate with one or more core networks or the internet through a radio access network (radio access network, RAN). The terminal device may be a mobile terminal device, for example, a mobile telephone (or referred to as a “cellular” phone or a mobile phone (mobile phone)), a computer, or a data card. For example, the terminal device may be a portable, pocket-sized, handheld, computer built-in, or vehicle-mounted mobile apparatus that exchanges voice and/or data with the radio access network. For example, the terminal device may be a device such as a personal communication service (personal communication service, PCS) phone, a cordless phone, a session initiation protocol (SIP) phone, a wireless local loop (wireless local loop, WLL) station, a personal digital assistant (personal digital assistant, PDA), a tablet computer (Pad), or a computer having a wireless transceiver function. The wireless terminal device may also be referred to as a system, a subscriber unit (subscriber unit), a subscriber station (subscriber station), a mobile console (mobile station), a mobile station (mobile station, MS), a remote station (remote station), an access point (access point, AP), a remote terminal (remote terminal) device, an access terminal (access terminal) device, a user terminal (user terminal) device, a user agent (user agent), a subscriber station (subscriber station, SS), customer premises equipment (customer premises equipment, CPE), a terminal (terminal), user equipment (user equipment, UE), a mobile terminal (mobile terminal, MT), or the like.

By way of example, and not limitation, in embodiments of this application, the terminal device may alternatively be a wearable device. The wearable device may also be referred to as a wearable intelligent device, an intelligent wearable device, or the like, and is a general term of wearable devices, such as glasses, gloves, watches, clothes, and shoes, that are developed by applying wearable technologies to intelligent designs of daily wear. The wearable device is a portable device that can be directly worn on the body or integrated into clothes or an accessory of the user. The wearable device is not only a hardware device, but also implements a powerful function through software support, data exchange, and cloud interaction. Generalized wearable intelligent devices include full-featured and large-size devices that can implement complete or partial functions without depending on smartphones, such as smart watches or smart glasses, and devices that focus on only one type of application function and need to work with other devices such as smartphones, for example, various smart bands, smart helmets, or smart jewelry.

Alternatively, the terminal may be an uncrewed aerial vehicle, a robot, a terminal in device-to-device (device-to-device, D2D) communication, a terminal in vehicle to everything (vehicle to everything, V2X), a virtual reality (virtual reality, VR) terminal device, an augmented reality (augmented reality, AR) terminal device, a wireless terminal in industrial control (industrial control), a wireless terminal in self driving (self driving), a wireless terminal in remote medical (remote medical), a wireless terminal in a smart grid (smart grid), a wireless terminal in transportation safety (transportation safety), a wireless terminal in a smart city (smart city), a wireless terminal in a smart home (smart home), or the like.

In addition, the terminal device may alternatively be a terminal device in a communication system (for example, a sixth generation (6th generation, 6G) communication system) evolved after a fifth generation (5th generation, 5G) communication system, a terminal device in a future evolved public land mobile network (public land mobile network, PLMN), or the like. For example, a 6G network may further extend a form and a function of a 5G communication terminal, and a 6G terminal includes but is not limited to a vehicle, a cellular network terminal (integrating a function of a satellite terminal), an uncrewed aerial vehicle, and an internet of things (internet of things, IoT) device.

(2) Network device: The network device may be a device in a wireless network. For example, the network device may be a RAN node (or device) through which the terminal device accesses the wireless network. The network device may also be referred to as a base station. Currently, some examples of RAN devices are a next-generation NodeB gNB (gNodeB) in a 5G communication system, a transmission reception point (transmission reception point, TRP), an evolved NodeB (evolved NodeB, eNB), a radio network controller (radio network controller, RNC), a NodeB (NodeB, NB), a home base station (for example, a home evolved NodeB, or a home NodeB, HNB), and a baseband unit (baseband unit, BBU). In addition, in a network structure, the network device may include a central unit (central unit, CU) node or a distributed unit (distributed unit, DU) node, or a RAN device including a CU node and a DU node.

The network device may be another apparatus that provides a wireless communication function for the terminal device. A specific technology and a specific device form that are used by the network device are not limited in embodiments of this application. For ease of description, this is not limited in embodiments of this application.

In embodiments of this application, an apparatus configured to implement a function of the network device may be a network device, or may be an apparatus, for example, a chip system, that can support the network device in implementing the function. The apparatus may be installed in the network device. In the technical solutions provided in embodiments of this application, an example in which the apparatus configured to implement the function of the network device is the network device is used to describe the technical solutions provided in embodiments of this application.

(3) Configuration and preconfiguration: In this application, both the configuration and the preconfiguration are performed. The configuration means that the network device/a server sends configuration information of some parameters or parameter values to the terminal by using a message or signaling, so that the terminal determines a communication parameter or a transmission resource based on the values or the information. Similar to the configuration, the preconfiguration may be parameter information or a parameter value negotiated by the network device/server with the terminal device in advance, or may be parameter information or a parameter value that is used by the base station/network device or the terminal device and that is specified in a standard protocol, or may be parameter information or a parameter value that is pre-stored in the base station/server or the terminal device. This is not limited in this application.

Further, these values and parameters may be changed or updated.

(4) Terms “system” and “network” may be used interchangeably in embodiments of this application. In addition, “a plurality of” means two or more. A term “and/or” describes an association relationship between associated objects and represents that three relationships may exist. For example, A and/or B may represent the following cases: Only A exists, both A and B exist, and only B exists, where A and B may be singular or plural. A character “/” generally indicates an “or” relationship between the associated objects. In addition, “at least one of the following items (pieces)” or a similar expression thereof indicates any combination of these items, including a single item (piece) or any combination of a plurality of items (pieces). For example, “at least one of A, B, and C” includes A, B, C, A and B, A and C, B and C, or A, B, and C. In addition, unless otherwise specified, ordinal numbers such as “first” and “second” mentioned in embodiments of this application are used to distinguish between a plurality of objects, but are not used to limit a sequence, a time sequence, priorities, or importance of the plurality of objects.

In this application, unless otherwise specified, for same or similar parts in embodiments, reference may be made to each other. In embodiments of this application and the methods/designs/implementations in embodiments, unless otherwise specified or logical conflicts occur, terms and/or descriptions between different embodiments and between the methods/designs/implementations in embodiments are consistent and may be mutually referenced, different embodiments and technical features in the methods/designs/implementations in embodiments may be combined to form a new embodiment, method, or implementation according to an internal logical relationship of embodiments. The following implementations of this application are not intended to limit the protection scope of this application.

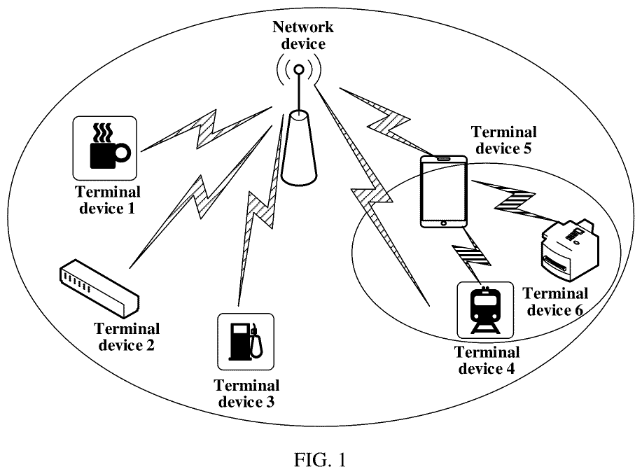

FIG. 1 is a diagram of a communication system according to this application. FIG. 1 shows an example of one network device 101 and six terminal devices. The six terminal devices are respectively a terminal device 1, a terminal device 2, a terminal device 3, a terminal device 4, a terminal device 5, and a terminal device 6. In the example shown in FIG. 1, an example in which the terminal device 1 is a smart teacup, the terminal device 2 is a smart air conditioner, the terminal device 3 is a smart fuel dispenser, the terminal device 4 is a vehicle, the terminal device 5 is a mobile phone, and the terminal device 6 is a printer is used for description.

As shown in FIG. 1, the network device may be an indication information (or configuration information) sending entity, and the terminal device 1 to the terminal device 6 may be indication information (or configuration information) receiving entities. In this case, the network device and the terminal device 1 to the terminal device 6 form a communication system. In the communication system, the terminal device 1 to the terminal device 6 may send uplink data to the network device, and the network device needs to receive the uplink data sent by the terminal device 1 to the terminal device 6. In addition, the network device may send indication information (or configuration information) to the terminal device 1 to the terminal device 6.

For example, in FIG. 1, the terminal device 4 to the terminal device 6 may alternatively form a communication system. The terminal device 5 serves as a network device, that is, an indication information (or configuration information) sending entity, and the terminal device 4 and the terminal device 6 serve as terminal devices, that is, indication information (or configuration information) receiving entities. For example, in an internet of vehicles system, the terminal device 5 separately sends indication information (or configuration information) to the terminal device 4 and the terminal device 6, and receives uplink data sent by the terminal device 4 and the terminal device 6. Correspondingly, the terminal device 4 and the terminal device 6 receive the indication information (or configuration information) sent by the terminal device 5, and send the uplink data to the terminal device 5.

It should be understood that this application may be applied to a long term evolution (long term evolution, LTE) system, a new radio (new radio, NR) system, or a communication system (for example, 6G) evolved after 5G. The communication system includes a network device and a terminal device.

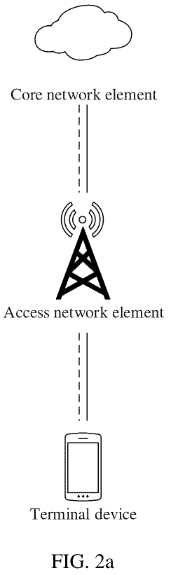

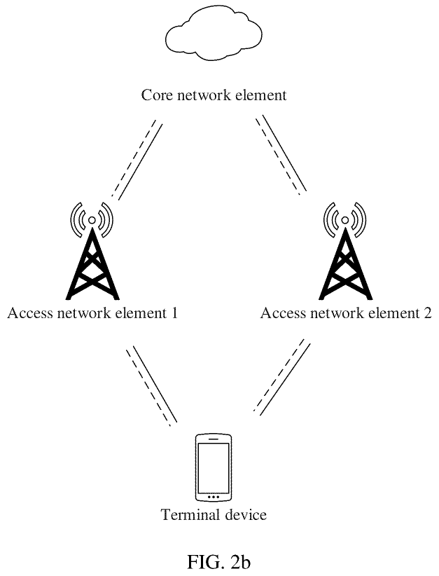

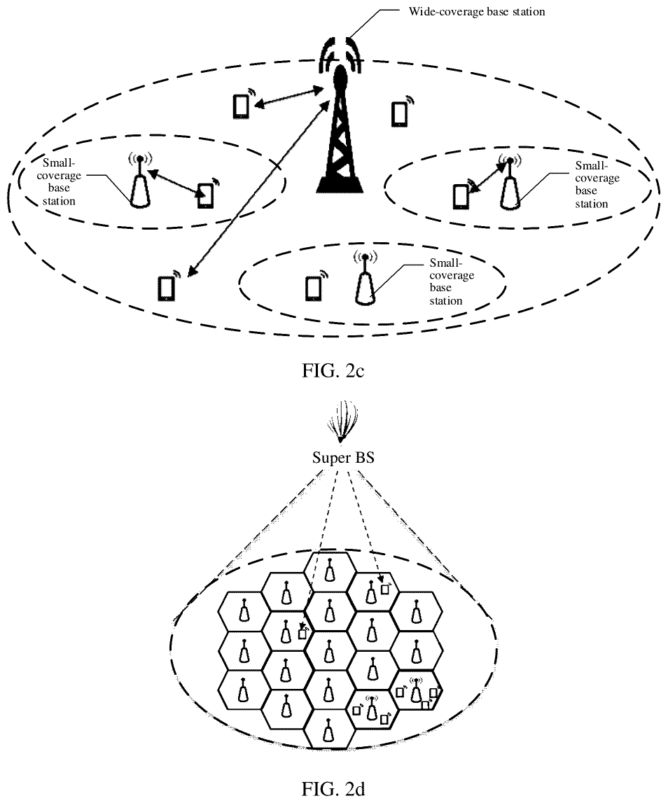

The following describes, by using implementation scenarios in FIG. 2a to FIG. 2d, an example of the communication system to which this application is applied. Possible system architectures of the communication system are shown in FIG. 2a and FIG. 2b. In the following example, an example in which the network device includes a 6G core network element (denoted as a 6G CORE), a 5G core network element (denoted as a 5G CORE), a 6G access network element (denoted as a 6G BS), a 5G access network element (denoted as a 5G BS), and the like is used for description.

FIG. 2a shows a standalone (standalone, SA) scenario: A terminal device is connected to a single access network element, and the access network element connected to the terminal device and a core network element connected to the access network element are of a same standard. Optionally, the standard may be a radio access technology (radio access technology, RAT).

For example, in an implementation process of a 5G standard, the core network element is a 5G core network element (denoted as a 5G Core), the access network element is a 5G access network element (denoted as a 5G BS), and the 5G BS is connected to the 5G Core.

For another example, in an implementation process of a 6G standard, the core network element is a 6G core network element (denoted as a 6G Core), the access network element is a 6G access network element (denoted as a 6G BS), and the 6G BS is connected to the 6G Core.

FIG. 2b shows a dual connectivity (dual connectivity, DC) scenario: A terminal device is connected to both an access network element 1 and an access network element 2. The access network element 1 and the access network element 2 may be access network elements of different standards, or access network elements of a same standard.

For example, a core network element is a 5G Core, and the terminal device is connected to both a 5G access network element and a 6G access network element, where the 5G access network element serves as a primary station, and the 6G access network element serves as a secondary station.

For another example, a core network is a 6G Core, and the terminal device is connected to both a 6G access network element and a 5G access network element, where the 6G access network element serves as a primary station, and the 5G access network element serves as a secondary station.

For still another example, a core network element is a 6G Core, and the terminal device is connected to two 6G access network elements, in other words, the 6G access network elements are a primary station and a secondary station.

In an implementation example, as shown in FIG. 2c, an example in which a network device name is a base station is used. This application may be applied to a scenario in which both a wide-coverage base station and a small-coverage base station exist.

In FIG. 2c, both the wide-coverage base station and the small-coverage base station may serve as access network elements of the terminal device. A signal coverage area (represented by a larger dashed ellipse box in FIG. 2c) of the wide-coverage base station is greater than a signal coverage area (represented by a smaller dashed ellipse box in FIG. 2c) of the small-coverage base station, and the signal coverage area of the wide-coverage base station and the signal coverage area of the small-coverage base station have an intersection.

Optionally, the signal coverage area of the small-coverage base station is a subset of the signal coverage area of the wide-coverage base station.

In an implementation example, as shown in FIG. 2d, an example in which a network device name is a base station is used. This application may be applied to a scenario in which both a super base station (super BS) and a terrestrial base station exist. The super BS may be a satellite, a high altitude platform station (high altitude platform station, HAPS), an air balloon station, an uncrewed aerial vehicle station, a broadcast station, or another implementation. The terrestrial base station may be a cellular station in a communication system, for example, a macro base station, a small cell, a micro base station, or another implementation.

In FIG. 2d, both the super BS and the terrestrial base station may serve as access network elements of the terminal device. A signal coverage area (represented by a dashed ellipse box in FIG. 2d) of the super BS is greater than a signal coverage area (represented by a hexagon box in FIG. 2d) of the terrestrial base station, and the signal coverage area of the super BS and the signal coverage area of the terrestrial base station have an intersection.

Optionally, in the scenarios shown in FIG. 2c and FIG. 2d, the base station with a larger signal coverage area may be referred to as a macro base station, and the base station with a smaller signal coverage area may be referred to as a micro base station. Therefore, the scenarios shown in FIG. 2c and FIG. 2d may also be referred to as macro-micro scenarios.

It should be noted that, during actual application, a shape of the signal coverage area is not limited to the foregoing implementations of the ellipse and the hexagon. For example, the shape of the signal coverage area may alternatively be a rectangle or a circle, or the shape of the signal coverage area may alternatively be an irregular shape. This is not limited herein.

It should be understood that, in any one of the foregoing communication systems, the terminal device may perform communication based on a low power consumption state of a radio resource control inactive (radio resource control inactive, RRC INACTIVE) state (or referred to as an INACTIVE state). In addition, the terminal device may alternatively perform communication in a radio resource control idle (radio resource control idle, RRC IDLE) state (or referred to as an IDLE state) or a radio access control connected (radio resource control connected, RRC CONNECTED) state (or referred to as a CONNECTED state).

With deployment of a large-scale antenna and a transceiver module that supports a high-frequency signal, energy consumption of a network device in a communication system is increasingly high. Therefore, reducing energy consumption of the network device is one of important requirements of the communication system. For example, the network device is a base station. Energy consumption of a 5G base station is higher than energy consumption of a 4G base station. Therefore, how to reduce energy consumption of the network device is an urgent technical problem to be resolved.

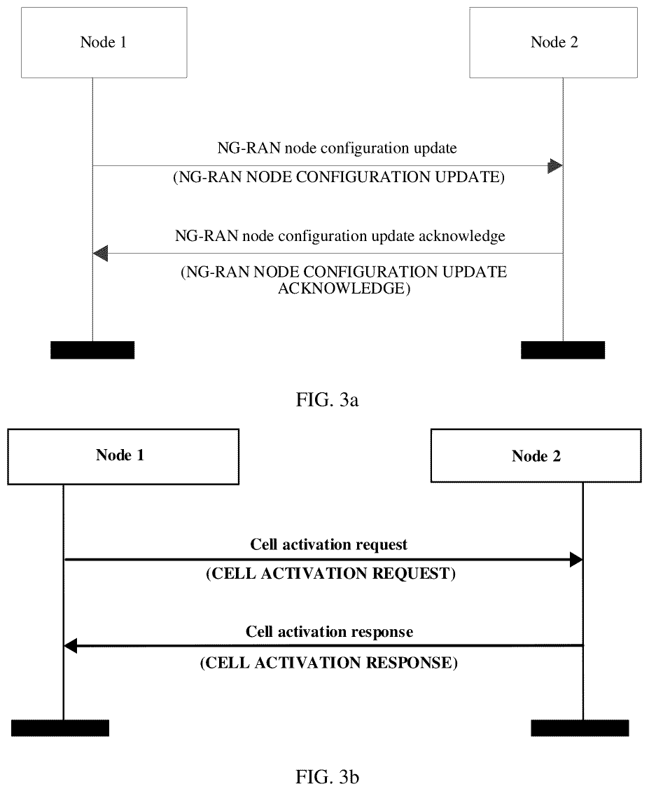

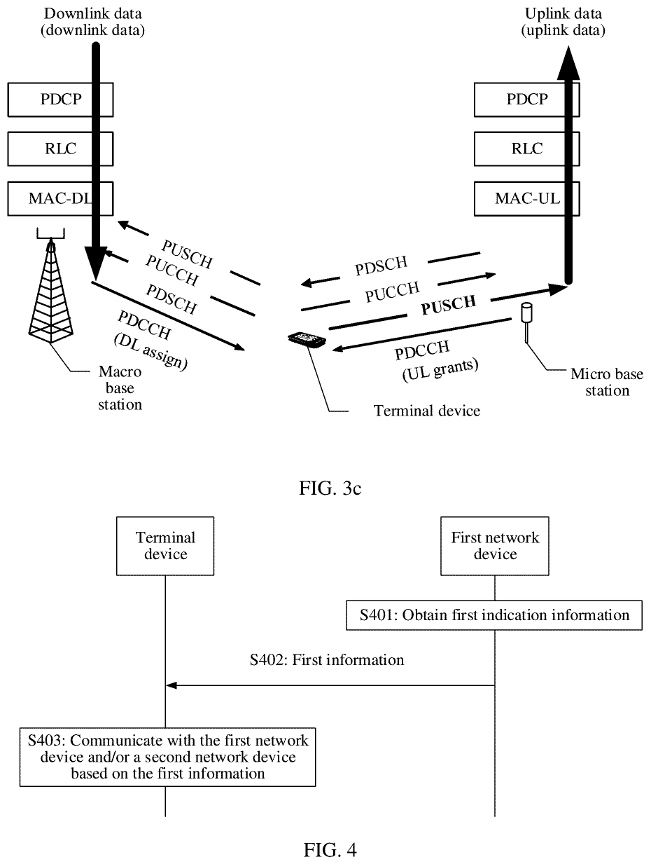

In an implementation of reducing energy consumption of the network device, energy consumption of the network device may be reduced by using a network device shutdown technology. After the network device is shut down, if a neighboring network device does not obtain information indicating that the network device is shut down and does not refresh a neighboring cell list in time, a service such as a cell handover may fail. Therefore, when a network device is activated/deactivated, indication information indicating that the network device is activated/deactivated may be exchanged with another network device through an Xn/X2 interface. An implementation scenario of a next generation radio access network (next generation radio access network, NG-RAN) is used as an example. The following further describes the implementation scenario by using implementation examples in FIG. 3a and FIG. 3b.

For example, in FIG. 3a, when a cell of a node 1 (denoted as an NG-RAN node 1) is activated/deactivated, the node 1 exchanges an NG-RAN node configuration update (NG-RAN NODE CONFIGURATION UPDATE) message and an NG-RAN node configuration update acknowledge (NG-RAN NODE CONFIGURATION UPDATE ACKNOWLEDGE) message with a node 2 (denoted as an NG-RAN node 2) through an Xn interface. The NG-RAN node configuration update message includes a cell activation/deactivation indication.

In addition, network devices may also send a cell activation request to request a neighboring base station to activate a cell. Similarly, the request and a reply message are also exchanged through an Xn/X2 interface.

For example, in FIG. 3b, after the node 2 is deactivated, the node 1 may send a cell activation request (CELL ACTIVATION REQUEST) message to the node 2, where the cell activation request message carries an activation request indication. Then, when the node 2 determines to be activated, the node 2 replies with a cell activation response (CELL ACTIVATION RESPONSE) message to the node 1. If the node 2 cannot activate any cell that the node 1 requests to activate, the node 2 replies with a cell activation failure (CELL ACTIVATION FAILURE) message to the node 1.

In the foregoing implementation process, only a notification of activation or deactivation between network devices is defined. In addition, in the foregoing implementation process, deactivation of a network device means that both an uplink transmission module and a downlink transmission module in the network device are disabled. In other words, in the foregoing implementation, both an uplink transmission module and a downlink transmission module in a same network device need to be disabled.

However, in the communication system, the network device is flexibly implemented, and the foregoing implementation process is excessively limited. As a result, the foregoing implementation needs to be further optimized.

The following describes the optimization process with reference to more embodiments.

In the macro-micro scenarios shown in FIG. 2c and FIG. 2d, to increase an overall cell capacity, a concept of a micro base station is introduced in a wireless communication system. In other words, in coverage of a macro base station, one or more deployed low-power base stations are referred to as a micro base station. In addition, considering that transmit power of the macro base station is generally greater than transmit power of the micro base station, a downlink signal may be sent by the macro base station to reduce power consumption of the micro base station. In addition, in signal coverage of the macro base station, a terminal device may select a micro base station that is close to the terminal device as a receiver of an uplink signal to reduce power consumption of the terminal device. In other words, uplink transmission and downlink transmission of the terminal device may be separated, to be specific, the terminal device receives the downlink signal from the macro base station, and the uplink signal of the terminal device is sent to the micro base station, thereby reducing power consumption of the micro base station.

In a possible implementation, in the foregoing macro-micro scenarios, a split bearer manner may be used for implementation. A signal bearer of the terminal device is split between the macro base station and the micro base station, the downlink signal is sent by the macro base station, and the uplink signal is received by the micro base station and sent to the macro base station for processing. Therefore, the macro base station may not configure an uplink physical channel (for example, a physical uplink shared channel (physical uplink shared channel, PUSCH)), and the micro base station may not configure an downlink physical channel (for example, a physical downlink shared channel (physical downlink shared channel, PDSCH)). It may be understood that, in an implementation process of the split bearer, because the micro base station has an uplink physical channel configuration, and the macro base station does not have an uplink physical channel configuration, after the terminal device receives the downlink signal, the terminal device needs to feed back feedback information (for example, a radio link control (radio link control, RLC) status report) for the downlink signal to the micro base station.

In a possible implementation, in the foregoing macro-micro scenarios, an independent bearer manner may be used for implementation. The macro base station and the micro base station have independent signal bearers. Therefore, the macro base station and the micro base station each have an uplink physical channel and a downlink physical channel. Correspondingly, after receiving the downlink signal sent by the macro base station, the terminal device may feed back feedback information for the downlink signal to the macro base station.

In an implementation example, as shown on a left side of FIG. 3c, a process of downlink transmission between the macro base station and the terminal device includes transmission of a channel such as a PDCCH of downlink (downlink, DL) assign (assign) or a PDSCH, and a process of uplink transmission between the macro base station and the terminal device includes transmission of a channel such as a PUSCH or a PUCCH.

In another implementation example, as shown on a right side of FIG. 3c, a process of uplink transmission between the micro base station and the terminal device includes a signal transmitted on a channel such as a PDCCH of uplink (uplink, UL) grants (grants), a PDSCH, a PUCCH, or a PUSCH. For example, in FIG. 3c, between the micro base station and the terminal device, an arrow at which the PUSCH is located indicates a transmission direction of the downlink signal of the macro base station, and an arrow at which the PDSCH is located indicates a transmission direction of the RLC status report reported by the terminal device.

It may be understood that, in an implementation process of the independent bearer, because the micro base station has a PUSCH configuration and the macro base station also has a PUSCH configuration, after the terminal device receives the downlink signal, the terminal device needs to feed back the RLC status report for the downlink signal to the network device that receives the downlink signal.

The following further describes the solutions provided in this application with reference to more embodiments.

FIG. 4 is a diagram of a communication method according to this application. The method includes the following steps.
S401: A first network device obtains first indication information.

In this embodiment, the first network device obtains the first indication information in step S401, where the first indication information indicates a mode of communication between the first network device and a terminal device and/or a mode of communication between a second network device and the terminal device, and the communication mode includes any one of the following: whether uplink transmission is activated, or whether downlink transmission is activated.

In a possible implementation, the communication mode includes at least one of the following: uplink transmission is activated and downlink transmission is deactivated, uplink transmission is deactivated and downlink transmission is activated, uplink transmission is activated, uplink transmission is deactivated, downlink transmission is activated, downlink transmission is deactivated, uplink transmission is activated and downlink transmission is activated, or uplink transmission is deactivated and downlink transmission is deactivated. Specifically, a communication mode that is of a network device (including the first network device and/or the second network device) and that is indicated by the first indication information obtained by the first network device may further include any one of the foregoing communication modes, so that the network device controls uplink transmission and downlink transmission more flexibly.

It should be understood that both the communication mode in which uplink transmission is activated and the communication mode in which uplink transmission is activated and downlink transmission is deactivated may indicate that an uplink transmission module in the network device is activated, both the communication mode in which uplink transmission is deactivated and the communication mode in which uplink transmission is deactivated and downlink transmission is activated may indicate that the uplink transmission module in the network device is deactivated, both the communication mode in which downlink transmission is activated and the communication mode in which uplink transmission is deactivated and downlink transmission is activated may indicate that a downlink transmission module in the network device is activated, and both the communication mode in which downlink transmission is deactivated and the communication mode in which uplink transmission is activated and downlink transmission is deactivated may indicate that the downlink transmission module in the network device is deactivated.

Optionally, in a plurality of implementations of the foregoing communication modes, different implementations indicating a same communication mode may be flexibly applied to different scenarios. For example, both the communication mode in which uplink transmission is activated and the communication mode in which uplink transmission is activated and downlink transmission is deactivated may indicate an implementation process of activating uplink transmission of the network device. When the network device has an uplink transmission module but does not have a downlink transmission module, the mode that is for communicating with the network device and that is determined by the terminal device is that uplink transmission is activated. When the network device has an uplink transmission module but does not have a downlink transmission module, the mode that is for communicating with the network device and that is determined by the terminal device is that uplink transmission is activated, or the mode that is for communicating with the network device and that is determined by the terminal device is that uplink transmission is activated and downlink transmission is deactivated.

Optionally, in comparison with implementation of the uplink transmission module in the network device, because a power amplifier component needs to be added to the downlink transmission module, it is generally considered that power consumption of the downlink transmission module in the network device is greater than power consumption of the uplink transmission module. As described in “White Paper of Energy Saving Technology of 5G Base Station” released by China Mobile, in a full load condition, a power consumption ratio of a power amplifier is the highest and about 58% on average; and in a no load condition, a power consumption ratio of a digital intermediate frequency part is the highest and about 46% on average. Therefore, in the foregoing implementation process, when the first indication information indicates that the communication mode of the network device (including the first network device and/or the second network device) is that downlink transmission is deactivated (or uplink transmission is activated and downlink transmission is deactivated), more gains of reducing power consumption of the network device can be obtained.

In step S401, the first network device may obtain the first indication information in a plurality of manners. The following provides descriptions by using some implementation examples.

Implementation 1: In step S401, the first network device receives the first indication information from a third device.

Specifically, in Implementation 1, the first indication information indicates the mode of communication between the first network device and the terminal device; and that a first network device obtains the first indication information in step S401 includes: The first network device receives the first indication information. Specifically, when the first indication information indicates the mode of communication between the first network device and the terminal device, the first network device may obtain the first indication information by receiving the first indication information, so that the first network device serves as a controlled network device, and the third device serves as a control device, to control energy consumption of the first network device.

Optionally, in Implementation 1, when the first indication information indicates the mode of communication between the first network device and the terminal device, the method further includes: The first network device updates the communication mode of the first network device based on the first indication information. Specifically, in an implementation process in which the first network device obtains the first indication information by receiving the first indication information, the first network device may further locally update the communication mode of the first network device based on the first indication information, so that the first network device disables an uplink transmission module configured to receive an uplink signal or disables a downlink transmission module configured to send a downlink signal, thereby reducing energy consumption of the first network device.

It should be understood that the first indication information may be from another network device different from the first network device, a network node, a network element, or a network management device. This is not limited herein. The following provides descriptions with reference to some implementation examples.

In a possible implementation, the first indication information may be from a network management device, that is, the third device is a network management device. The network management device may be an OAM device, an OSS, or another device used for network management. This is not limited herein. An implementation process of the OAM device is used as an example herein. The OAM device may obtain, from each network device (including the first network device), a quantity of connected users of each network device, an amount of user data transmitted by each network device, indication information indicating a load status of each network device, service frequency information of each network device, signal coverage area information of each network device, or other information; and the OAM device determines and indicates a communication mode of each network device based on the obtained information.

For example, when the OAM device determines that the quantity of connected users of the first network device is less than a threshold (or the amount of user data transmitted by the first network device is less than a threshold), the OAM device may send the first indication information to the first network device, and indicate, by using the first indication information, the uplink transmission module configured to receive an uplink signal in the first network device to be disabled or the downlink transmission module configured to send a downlink signal to be disabled, thereby reducing energy consumption of the first network device.

In another possible implementation, the first indication information may be from another network device different from the first network device, that is, the third device is another network device different from the first network device. The indication information indicating the communication mode may be transmitted between different network devices through an inter-station interface (or an optical fiber, a wireless interface, or the like). In other words, in step S401, the third device sends the first indication information to the first network device through an inter-station interface (or an optical fiber, a wireless interface, or the like). The following provides example descriptions with reference to a plurality of implementation examples.

Example 1: The another network device may include the first indication information to a RAN node configuration update message.

Example 2: When the first network device is activated in uplink transmission and activated in downlink transmission, the first network device sends a disable request message to the another network device. After the another network device receives the disable request message from the first network device, the third device replies with a disable request reply message, where the disable request reply message carries the first indication information. In addition, the first indication information indicates that the communication mode of the first network device is that uplink transmission is deactivated (and/or downlink transmission is deactivated).

Optionally, when the first network device is activated in uplink transmission and activated in downlink transmission, the first network device sends a disable request message to the third device. After the third device receives the disable request message from the first network device, the third device replies with a disable request reject message. After the first network device receives the disable request reject message, the first network device keeps uplink transmission and downlink transmission of the first network device activated.

Example 3: When the first network device is deactivated in uplink transmission and deactivated in downlink transmission (or the first network device is in a sleep state), the first network device receives, from the another network device, a wake-up signal (or a cell activation request) that carries the first indication information. The first indication information indicates that the communication mode of the first network device is that uplink transmission is activated (and/or downlink transmission is activated).

It should be understood that Example 3 describes a scenario in which both uplink transmission and downlink transmission of the first network device are deactivated. During actual application of the solution, the sleep state of the first network device may be further extended, to be specific, the first network device is in an uplink-activated and downlink-deactivated (or uplink-deactivated and downlink-activated) state. In this scenario, the another network device may send the first indication information to the first network device by using Example 1 or Example 2, so that the first network device switches to the communication mode specified by the first indication information.

Optionally, in Example 3, the another network device may trigger sending of the first indication information based on a load status of the first network device, or may trigger sending of the first indication information when detecting that some specific users exist in a coverage area of the another network device, so that the first network device wakes up.

Further, optionally, the specific user may include an ultra-reliable and low latency communications (ultra-reliable low-latency communications, URLLC) user, another user having a high requirement on a latency, or the like.

Implementation 2: That a first network device obtains first indication information in step S401 includes: The first network device generates the first indication information.

In Implementation 2, the first indication information indicates the mode of communication between the second network device and the terminal device; and that a first network device obtains the first indication information in step S401 includes: The first network device determines the first indication information. The method further includes: The first network device sends the first indication information to the second network device. Specifically, when the first indication information indicates the mode of communication between the second network device and the terminal device, the first network device sends the first indication information to the second network device after determining the first indication information. Therefore, the second network device serves as a controlled network device, and the first network device serves as a control device, to control energy consumption of the second network device, thereby reducing energy consumption of the second network device.

Optionally, in Implementation 1 or Implementation 2, in a transmission process of the first indication information, the first indication information is included in any one of the following: a RAN node configuration update (RAN NODE CONFIGURATION UPDATE) message, a disable request reply message, a disable request reject message, or a cell activation request (CELL ACTIVATION REQUEST) message. Specifically, the first indication information may be carried in any one of the foregoing messages, so that the first network device and/or the second network device receive/receives the first indication information based on any one of the foregoing messages, and energy consumption is reduced based on the first indication information.
S402: The first network device sends first information.

In this embodiment, the first network device sends the first information in step S402, and correspondingly the terminal device obtains the first information in step S402. The first information is associated with the mode of communication between the first network device and the terminal device and/or the mode of communication between the second network device and the terminal device.

Specifically, after the first network device obtains the first indication information in step S401, the first network device generates and sends the first information based on the first indication information in step S402.
S403: The terminal device communicates with the first network device and/or the second network device based on the first information.

In this embodiment, after the terminal device obtains the first information in step S402, the terminal device communicates with the first network device and/or the second network device based on the first information in step S403.

In a possible implementation, the first information is associated with the mode of communication between the first network device and the terminal device, where the first information includes at least one of the following: indication information (denoted as information A below) indicating that uplink configuration information between the terminal device and the first network device remains unchanged, and information about association (denoted as information B below) between an uplink DRB and a downlink DRB of the terminal device, encrypted information (denoted as information C below) of uplink transmission between the terminal device and the first network device, or indication information (denoted as information D below) indicating the communication mode of the first network device.

In a possible implementation, implementation of the information A to the information C is applicable to a scenario in which uplink transmission between the terminal device and the first network device does not change and downlink transmission of the first network device changes. For example, the first network device changes from downlink transmission activated to downlink transmission deactivated. For another example, the first network device changes from downlink transmission deactivated to downlink transmission activated.

For example, before the first network device obtains the first indication information in step S401, if uplink transmission of the first network device is activated and downlink transmission of the first network device is activated, and the first indication information indicates that the communication mode of the first network device is that uplink transmission is activated and downlink transmission is deactivated, the first information sent by the first network device may include the information A. Therefore, the terminal device determines, in step S403 based on the information A, that uplink transmission between the terminal device and the first network device does not change. In other words, before and after step S403, an uplink signal of the terminal device is sent to the first network device.

For another example, when the first indication information obtained by the first network device in step S401 indicates that the communication mode of the first network device is that uplink transmission is activated and downlink transmission is deactivated (or uplink transmission is deactivated and downlink transmission is activated), uplink transmission and downlink transmission of the terminal device respectively correspond to different network devices. In this case, the first information sent by the first network device may include the information B, that is, the information B indicates, to the terminal device, uplink DRBs associated (or paired) with downlink DRBs. Therefore, the terminal device determines, in step S403 based on the information B, that the uplink DRB of the terminal device does not change and the downlink DRB of the terminal device changes. In other words, before step S403, both the uplink DRB and the downlink DRB of the terminal device correspond to the first network device, and after step S403, the terminal device determines, based on the information B, that the uplink DRB and the downlink DRB respectively correspond to different network devices.

Optionally, the information B may carry configuration information of the uplink DRB and configuration information of the downlink DRB, or the information B carries configuration information of a changed DRB (for example, when the downlink DRB changes, the information B carries the configuration information of the downlink DRB).

It may be understood that, when uplink transmission and downlink transmission of the terminal device correspond to a same network device, a DRB configured by the network device for the terminal device is a bidirectional DRB, that is, the DRB may carry both uplink data and downlink data. However, in this embodiment, uplink transmission and downlink transmission of the terminal device may be performed on different network devices, that is, the uplink DRB and the downlink DRB of the terminal device respectively correspond to different network devices. Therefore, through delivery of the information B, the terminal device can determine, based on the information B, that the uplink DRB is associated with the downlink DRB, to achieve a bidirectional DRB effect.

For another example, when the first indication information obtained by the first network device in step S401 indicates that the communication mode of the first network device is that uplink transmission is activated and downlink transmission is deactivated (or uplink transmission is deactivated and downlink transmission is activated), the first information sent by the first network device may include the information C, so that the terminal device subsequently encrypts uplink data based on the information C, to improve data transmission security.

Optionally, the encrypted information in the information C may include a key, an encryption algorithm, an integrity protection algorithm, and the like.

Optionally, the information D is used to enable the terminal device to obtain the communication mode of the first network device and/or the communication mode of the second network device.

Specifically, when uplink transmission between the terminal device and the first network device does not change and downlink transmission of the first network device changes (for example, downlink transmission activated is changed to downlink transmission deactivated, or downlink transmission deactivated is changed to downlink transmission activated), the terminal device may further communicate with the first network device based on at least one of the foregoing information.

The implementation processes of the information A to the information D describe the following: The first information may be applied to a scenario in which uplink transmission between the terminal device and the first network device does not change and downlink transmission of the first network device changes. Similarly, if the first information is applied to a scenario in which downlink transmission between the terminal device and the first network device does not change and uplink transmission of the first network device changes, the first information includes at least one of the following: indication information (denoted as information E below) indicating that downlink configuration information between the terminal device and the first network device remains unchanged, information about association (denoted as information F below) between an uplink DRB and a downlink DRB of the terminal device, encrypted information (denoted as information G below) of downlink transmission between the terminal device and the first network device, or indication information (denoted as information H below) indicating the communication mode of the first network device.

It should be understood that, for implementation processes of the information E to the information H, reference may be made to the foregoing implementation processes of the information A to the information D, and corresponding technical effects are implemented. A difference lies in that uplink related information and downlink related information are exchanged. Details are not described herein.

In a possible implementation, the first information is included in any one of the following: a radio resource control (radio resource control, RRC) reconfiguration message or an RRC release message. Specifically, when the terminal device is in an RRC connected state, the terminal device may obtain the first information by using an RRC connection to the network device. The first information may be carried in an RRC message (for example, the RRC reconfiguration message or the RRC release message), so that the terminal device obtains the first information based on the RRC message and communicates with the first network device and/or the second network device based on the first information.

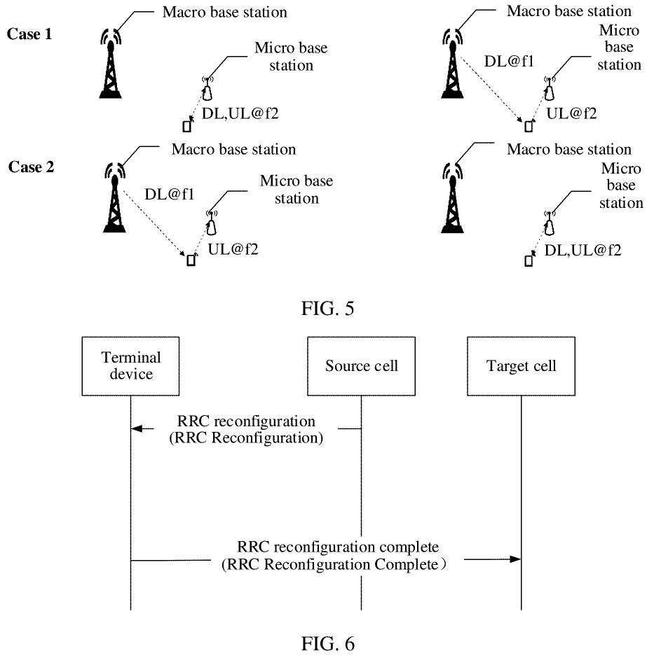

The following describes an example of an implementation process of the first information by using an implementation example shown in FIG. 5.

In a possible implementation, when the terminal device is in a connected state, both a sender of a downlink signal of the terminal device and a receiver of an uplink signal of the terminal device may be the first network device. However, when the first network device needs to switch to the uplink-activated and downlink-deactivated communication mode based on the first indication information in the foregoing embodiment, the receiver of the uplink signal of the terminal device is still the first network device, and the sender of the downlink signal of the terminal device is changed to another network device (for example, a macro base station). Therefore, switching of the terminal device between an uplink-downlink co-site and an uplink-downlink cross-site is involved. In other words, when the communication mode of the first network device changes, to change a transmission path of the terminal device, the first network device may send the RRC message (for example, the RRC reconfiguration message or the RRC release message) carrying the first information, so that the terminal device determines the change of the communication mode of the first network device based on the first information in the RRC message. For implementation of the first information, refer to the descriptions in the foregoing embodiment. Details are not described herein again.

A possible change scenario is shown in Case 1 (Case 1) in FIG. 5: The first network device is a micro base station (a frequency is denoted as f2) in the figure. Before state switching of the micro base station (that is, before an arrow in Case 1 in FIG. 5), both uplink transmission and downlink transmission of the terminal device are processed by the micro base station. In addition, the first indication information obtained by the first network device indicates that the communication mode of the first network device is that uplink transmission is activated and downlink transmission is deactivated. Therefore, after state switching of the micro base station (that is, after the arrow in Case 1 in FIG. 5), uplink transmission of the terminal device is still processed by the micro base station, but downlink transmission of the terminal device is processed by a macro base station (a frequency is denoted as f1). In this case, the micro base station serves as the first network device, and the micro base station may perform an implementation process of step S402, that is, the micro base station sends the first information to the terminal device in step S402.

Another possible change scenario is shown in Case 2 (Case 2) in FIG. 5: The first network device is a micro base station in the figure. Before an arrow in Case 2 in FIG. 5, uplink transmission of the terminal device is processed by the micro base station, and downlink transmission of the terminal device is processed by a macro base station. In other words, before the arrow in Case 2 in FIG. 5, a communication mode of the micro base station is that uplink transmission is activated and downlink transmission is deactivated. Then, because the first indication information obtained by the first network device indicates that the communication mode of the first network device (that is, the micro base station) is that uplink transmission is activated and downlink transmission is activated, after the arrow in Case 2 in FIG. 5, both uplink transmission and downlink transmission of the terminal device are processed by the micro base station. In this case, the micro base station serves as the first network device, and the micro base station may perform an implementation process of step S402, that is, the micro base station sends the first information to the first network device in step S402.

It should be noted that, in the scenario shown in FIG. 5, if a downlink transmission path of the terminal device changes, a cell handover procedure of the terminal device may be reused in a transmission process of the first information, that is, the first information may be carried in the RRC reconfiguration (RRC Reconfiguration) message. For example, when the first network device sends the RRC reconfiguration message including the first information to the terminal device in step S402, the terminal device may send an RRC reconfiguration complete (RRC Reconfiguration Complete) message based on the RRC reconfiguration message. An implementation process may be shown in FIG. 6. The first network device serves as a network device in which a source cell in FIG. 6 is located. Because the downlink transmission path of the terminal device changes to another network device (that is, a network device in which a target cell is located, for example, the macro base station in Case 1 in FIG. 5, or the micro base station in Case 2 in FIG. 5), the terminal device may send the RRC reconfiguration complete message to the network device in which the target cell is located. In other words, in Case 1 in FIG. 5, the terminal device sends the RRC reconfiguration complete message to the macro base station; and in Case 2 in FIG. 5, the terminal device sends the RRC reconfiguration complete message to the micro base station.

It should be understood that, in a scenario shown in FIG. 6, after the terminal device receives an RRC reconfiguration message including configuration information corresponding to a change of an uplink transmission path (or a change of a downlink transmission path), a difference from a common handover scenario with a procedure in which an RRC reconfiguration message includes configuration information corresponding to changes of both uplink and downlink transmission paths (after receiving a handover command, the terminal device initiates random access to the network device in which the target cell is located) is that, in the foregoing implementation process, the terminal device skips a process of initiating random access to the target cell, and the terminal device may reply with an RRC reconfiguration complete message after the configuration information carried in the RRC reconfiguration message takes effect.

In addition, in a scenario of uplink and downlink inter-site decoupling, the RRC reconfiguration message is sent through a downlink communication path. For example, in a scenario before the arrow in Case 1 in FIG. 5, the RRC reconfiguration message is sent by the micro base station. For another example, in a scenario before the arrow in Case 2 in FIG. 5, the RRC reconfiguration message is sent by the macro base station. Correspondingly, the RRC reconfiguration complete message is received through the uplink transmission path. For example, in a scenario after the arrow in Case 1 in FIG. 5, the RRC reconfiguration complete message is received by the micro base station. For another example, in a scenario before the arrow in Case 2 in FIG. 5, the RRC reconfiguration complete message is received by the micro base station.

Optionally, after the terminal device receives the RRC reconfiguration message, when the uplink transmission path of the terminal device remains unchanged, the terminal device may send an uplink signal based on a locally maintained timing advance (timing advance, TA) value.

Optionally, when the terminal device determines, (based on the first information or in another manner), that a cell is an uplink-only (UL only) cell, if a carrier corresponding to the cell is a time division multiplexing time division duplex (time division duplex, TDD) carrier or a full-duplex carrier, when the terminal device accesses the cell, the terminal device performs sending only on an uplink symbol/slot, and does not perform related receiving on a downlink symbol/slot.

It should be noted that, when the terminal device is in an RRC INACTIVE state, the terminal device may obtain the first information by using an RRC release (RRC release) message. In addition, for an implementation process of the first information, refer to the foregoing implementation of the connected state. Details are not described herein again.

It should be understood that, in Case 1 in FIG. 5, a scenario in which both the uplink transmission path and the downlink transmission path of the terminal device are connected to the micro base station is changed to a scenario in which the uplink transmission path of the terminal device is connected to the micro base station and the downlink transmission path of the terminal device is connected to the macro base station; and in Case 2 in FIG. 5, a scenario in which the uplink transmission path of the terminal device is connected to the micro base station and the downlink transmission path of the terminal device is connected to the macro base station is changed to a scenario in which both the uplink transmission path and the downlink transmission path of the terminal device are connected to the micro base station. The two change processes may be referred to as that the uplink transmission path of the terminal device does not change and the downlink transmission path of the terminal device changes.

During actual application of the solution, the implementation shown in FIG. 5 is merely an example, and this application may alternatively be applied to another scenario. For example, a scenario in which both the uplink transmission path and the downlink transmission path of the terminal device are connected to the micro base station is changed to a scenario in which the uplink transmission path of the terminal device is connected to the macro base station and the downlink transmission path of the terminal device is connected to the micro base station. For another example, a scenario in which the uplink transmission path of the terminal device is connected to the micro base station and the downlink transmission path of the terminal device is connected to the macro base station is changed to a scenario in which both the uplink transmission path and the downlink transmission path of the terminal device are connected to the macro base station. The two change processes may be referred to as that the downlink transmission path of the terminal device does not change and the uplink transmission path of the terminal device changes.

It may be understood that, in the scenario in which the downlink transmission path of the terminal device does not change and the uplink transmission path of the terminal device changes, for an implementation of the first information, refer to the foregoing implementation process of the first information in the scenario in which the uplink transmission path of the terminal device does not change and the downlink transmission path of the terminal device changes. For example, the first information may include indication information indicating that downlink configuration information between the terminal device and the first network device remains unchanged. For another example, the first information may include indication information indicating that encrypted information of uplink transmission between the terminal device and the first network device is the same as encrypted information of downlink transmission. For another example, the first information may include indication information indicating the communication mode of the first network device. In addition, for technical effects brought by a related implementation process, refer to the foregoing descriptions. Details are not described herein again.

In a possible implementation, the first information is carried in a system message, specifically, in but not limited to the following possible manners:

Manner 1: The first information indicates a communication mode corresponding to one or more cells, and the one or more cells include a cell of the first network device and/or a cell of the second network device.

Optionally, the first information is included in a SIB. Further, optionally, when the first information is included in the SIB, the SIB includes a first cell list, a cell indicated by the first cell list includes the cell corresponding to the first network device and/or the cell corresponding to the second network device, and the first information indicates a communication mode of the cell indicated by the first cell list.

Optionally, in Manner 1, for an uplink-only cell, the first information is carried in a system message of another cell near the uplink-only cell. For example, a list of cells for which only an uplink is enabled is defined in the system message (that is, the cell list includes one or more uplink-only cells).

It should be understood that the uplink-only cell and the another cell that sends the system message may be of a same standard, or may be of different standards. For example, the cell for which only an uplink is enabled is a 6G cell, and a cell to which a notification message is sent is a 5G cell, that is, a cross-standard notification is supported.

Manner 2: The first information indicates a communication mode of a network device corresponding to one or more SSB identifiers, and the network device corresponding to the one or more SSB identifiers includes the first network device and/or the second network device.

Optionally, the first information is included in a SIB.

Further, optionally, when the first information is included in the SIB, the SIB further includes the one or more SSB identifiers, the network device corresponding to the one or more SSB identifiers includes the first network device and/or the second network device, and the first information indicates the communication mode of the network device corresponding to the one or more SSB identifiers.

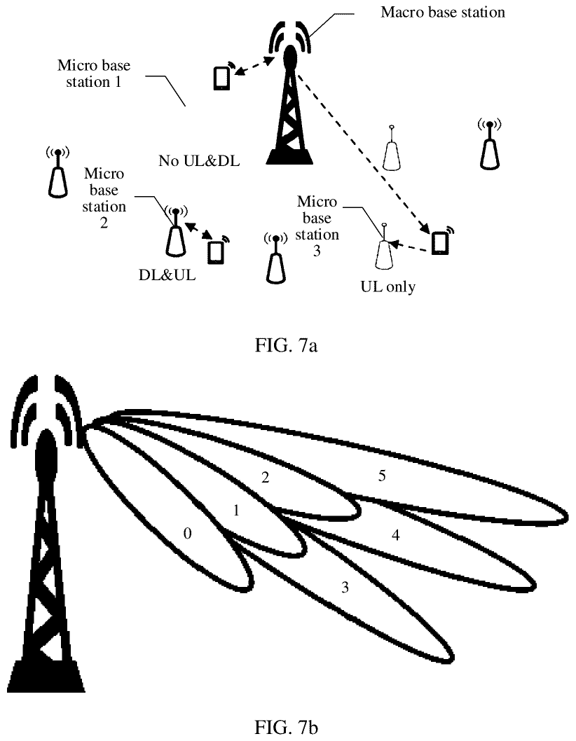

Optionally, in Manner 2, different SSB identifiers correspond to different SSBs. Generally, different SSBs are sent by using different beams. Therefore, different SSB identifiers may also correspond to different beams. An implementation shown in FIG. 7b is used as an example. Different pieces of elliptic information respectively represent different beams (for example, indexes #0, #1, #2, #3, #4, and #5 in the figure), and a sender of the different beams may be a macro base station. The first information received by the terminal device may indicate that a communication mode of a network device corresponding to a beam (for example, the beam whose index is #4) is uplink-only (or uplink transmission activated and downlink transmission deactivated).

It should be understood that, in Manner 2, a sender of the first information may be a macro base station shown in FIG. 7b, or the sender of the first information may be a micro base station having an intersection with signal coverage of the macro base station, or the sender of the first information may be another macro base station adjacent to the macro base station. This is not limited herein.

Manner 3: The first information indicates a communication mode of a network device in one or more areas corresponding to one or more area identifiers, and the network device in the one or more areas corresponding to the one or more area identifiers includes the first network device and/or the second network device.

Optionally, the first information is included in a SIB. Further, optionally, when the first information is included in the SIB, the SIB includes the one or more area identifiers, the network device in the one or more areas indicated by the one or more area identifiers includes the first network device and/or the second network device, and the first information indicates the communication mode of the network device in the one or more areas indicated by the one or more area identifiers.

Optionally, in Manner 3, an area-based notification may be further implemented in the SIB. In other words, the network device divides a geographical area into areas or zones (zones), and the first network device adds, to the SIB, indication information indicating a communication mode of each area.

Further, optionally, in Manner 3, the SIB may carry configuration information of each area, for example, a length of the area and a width of the area, so that the terminal device determines information about each area.

Network devices having different communication modes may be classified into different types of network devices. As shown in FIG. 7a, the network devices may include a macro base station activated in both an uplink and a downlink, a micro base station 1 deactivated in both an uplink and a downlink, a micro base station 2 activated in both an uplink and a downlink, a micro base station 3 activated only in an uplink (or activated in an uplink and deactivated in a downlink), and the like. Therefore, for a terminal device in an idle state, uplink and downlink paths used when the terminal device initiates random access may be different, that is, correspond to different network devices. Considering that an uplink-only network device does not send a downlink signal, correspondingly, from a perspective of the terminal device, cell information corresponding to the uplink-only network device cannot be obtained by receiving broadcast information (for example, an SSB or a SIB). In addition, because the terminal device needs to perform processing such as power control on a related uplink signal in a random access phase and a subsequent uplink data transmission phase, the terminal device needs to be notified that there is a network device for which only an uplink is enabled. Therefore, when the terminal device is in an idle state, the terminal device may obtain the first information in step S403 by receiving/detecting a broadcast message from the first network device. The first information may indicate the communication mode of the network device (including the first network device and/or the second network device) by using the cell-related information, the SSB identifier-related information, the area-related information, or the like, so that the terminal device communicates with the first network device and/or the second network device based on the first information.

For example, for the micro base station 3 (activated only in an uplink, or activated in an uplink and deactivated in a downlink) in the scenario shown in FIG. 7a, because the micro base station 3 does not activate downlink transmission, the micro base station 3 cannot indicate a communication mode of the micro base station 3 by using a broadcast message (for example, an SSB or a SIB). Therefore, a manner of sending broadcast information by a network device (for example, a macro base station or the micro base station 2) that is adjacent to the micro base station 3 and that activates uplink transmission may indicate the communication mode of the micro base station 3. The following describes the foregoing three manners by using an example in which a macro base station sends broadcast information.

In Manner 1, the first information is carried in a SIB sent by a macro base station, where the first information is used in the SIB to indicate a list of cells for which only an uplink is enabled, that is, the cell list includes a cell identifier of one or more uplink-only cells corresponding to the micro base station 3.

In Manner 2, the first information is carried in a SIB sent by a macro base station, where the first information is used in the SIB to indicate that a beam corresponding to one or more SSB identifiers is a communication beam for which only an uplink is enabled, and some or all of the one or more SSB identifiers identify communication beams corresponding to the micro base station 3.

In Manner 3, the first information is carried in a SIB sent by a macro base station, where the first information is used in the SIB to indicate that one or more communication areas are areas in which a communication beam for which only an uplink is enabled is located, and some or all of the one or more communication areas are communication areas corresponding to the micro base station 3.

It should be noted that, in addition to the foregoing implementation processes, in step S402, the sender of the first information may alternatively be another terminal device, and in a sidelink (Sidelink) based communication mode in step S402, the terminal device receives the first information in step S402, and communicates with the network device (for example, the first network device and/or the second network device) based on the first information.

In conclusion, the terminal device obtains, in step S402, the first information associated with the mode of communication between the first network device and the terminal device and/or the mode of communication between the second network device and the terminal device, and the terminal device communicates with the first network device and/or the second network device based on the first information in step S403. In other words, in a network device (including the first network device and/or the second network device), an uplink transmission module configured to receive an uplink signal is disabled, or a downlink transmission module configured to send a downlink signal is disabled, so that control of the uplink and downlink transmission modules in the network device is decoupled, so as to improve flexibility and reduce energy consumption of the network device, thereby reducing operating expenses of the network device.

In the technical solution in this embodiment of this application, there is no need to limit a case in which both an uplink transmission module and a downlink transmission module in a same network device are disabled. In other words, the foregoing technical solution can be applied to a communication system in which an uplink transmission module and a downlink transmission module are decoupled from different network devices, for example, a communication system formed by a wide-coverage base station and a small-coverage base station, or a communication system formed by an air base station and a terrestrial station, and can reduce energy consumption of the network devices in this scenario.

In the technical solution in this embodiment of this application, there is no need to limit a case in which the network device has both the uplink transmission module and the downlink transmission module, so that the foregoing technical solution can be applied to a scenario in which the network device has the uplink transmission module but does not have the downlink transmission module (or the network device has the downlink transmission module but does not have the uplink transmission module).

Optionally, in the communication system in which the uplink transmission module and the downlink transmission module are decoupled from different network devices, the terminal device may perform uplink communication with a network device that is closer to the terminal device, and a communication mode of the network device accessed by the terminal device is an implementation in which uplink transmission is activated and downlink transmission is deactivated. Because the uplink transmission module in the network device remains in an activated state, the terminal device does not need to increase transmit power, thereby avoiding an increase in energy consumption of the terminal device.

Refer to FIG. 8. An embodiment of this application provides a communication apparatus 800. The communication apparatus 800 can implement functions of the terminal device in the foregoing method embodiment, and therefore can also implement beneficial effects of the foregoing method embodiment. In this embodiment of this application, the communication apparatus 800 may be the terminal device, or may be an integrated circuit, an element, or the like inside the terminal device, for example, a chip. In the following embodiment, an example in which the communication apparatus 800 is the terminal device is used for description.

The apparatus 800 includes a processing unit 801 and a transceiver unit 802. The transceiver unit 802 is configured to obtain first information, where the first information is associated with a mode of communication between a first network device and the terminal device and/or a mode of communication between a second network device and the terminal device, and the communication mode includes any one of the following: whether uplink transmission is activated, or whether downlink transmission is activated; and the processing unit 801 is configured to communicate with the first network device and/or the second network device based on the first information.

In a possible implementation, the communication mode includes at least one of the following: uplink transmission is activated and downlink transmission is deactivated, uplink transmission is deactivated and downlink transmission is activated, uplink transmission is activated, uplink transmission is deactivated, downlink transmission is activated, downlink transmission is deactivated, uplink transmission is activated and downlink transmission is activated, or uplink transmission is deactivated and downlink transmission is deactivated.

In a possible implementation, the first information is included in any one of the following: a radio resource control RRC reconfiguration message or an RRC release message.

In a possible implementation, the first information indicates a communication mode corresponding to one or more cells, and the one or more cells include a cell of the first network device and/or a cell of the second network device; the first information indicates a communication mode of a network device corresponding to one or more SSB identifiers, and the network device corresponding to the one or more SSB identifiers includes the first network device and/or the second network device; or the first information indicates a communication mode of a network device in one or more areas corresponding to one or more area identifiers, and the network device in the one or more areas corresponding to the one or more area identifiers includes the first network device and/or the second network device.

Optionally, the first information is included in a SIB.

Further, optionally, when the first information is included in the SIB, the SIB includes at least one of the following: a first cell list, where a cell indicated by the first cell list includes a cell corresponding to the first network device and/or a cell corresponding to the second network device; one or more SSB identifiers, where a network device corresponding to the one or more SSB identifiers includes the first network device and/or the second network device; or one or more area identifiers, where a network device in one or more areas indicated by the one or more area identifiers includes the first network device and/or the second network device.

In a possible implementation, the first information is associated with the mode of communication between the first network device and the terminal device, where the first information includes at least one of the following: indication information indicating that uplink configuration information between the terminal device and the first network device remains unchanged; information about association between an uplink data radio bearer DRB and a downlink DRB of the terminal device; encrypted information of downlink transmission between the terminal device and the first network device; or indication information indicating the communication mode of the first network device.

It should be noted that, for content such as an information execution process of the units in the communication apparatus 800, refer to the descriptions in the foregoing method embodiment of this application. Details are not described herein again.

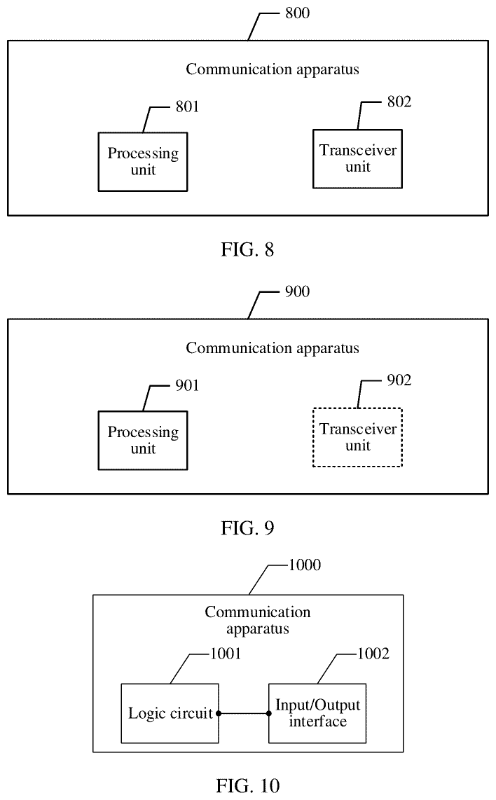

Refer to FIG. 9. An embodiment of this application provides a communication apparatus 900. The communication apparatus 900 can implement functions of the first network device in the foregoing method embodiment, and therefore can also implement beneficial effects of the foregoing method embodiment. In this embodiment of this application, the communication apparatus 900 may be the first network device, or may be an integrated circuit, an element, or the like inside the first network device, for example, a chip. In the following embodiment, an example in which the communication apparatus 900 is the first network device is used for description.

The apparatus 900 includes a processing unit 901. The processing unit 901 is configured to obtain first indication information, where the first indication information indicates a mode of communication between the first network device and a terminal device and/or a mode of communication between a second network device and the terminal device, and the communication mode includes any one of the following: whether uplink transmission is activated, or whether downlink transmission is activated. The processing unit 901 is further configured to determine the communication mode based on the first indication information.

In a possible implementation, the communication mode includes at least one of the following: uplink transmission is activated and downlink transmission is deactivated, uplink transmission is deactivated and downlink transmission is activated, uplink transmission is activated, uplink transmission is deactivated, downlink transmission is activated, downlink transmission is deactivated, uplink transmission is activated and downlink transmission is activated, or uplink transmission is deactivated and downlink transmission is deactivated.

In a possible implementation, the apparatus further includes a transceiver unit, and the transceiver unit 902 is configured to send first information, where the first information is associated with the communication mode.

In a possible implementation, the first information is included in any one of the following: a radio resource control RRC reconfiguration message or an RRC release message.

In a possible implementation, the first information meets at least one of the following: a SIB includes the first information and a first cell list, the first information indicates a communication mode of a cell indicated by the first cell list, and the cell indicated by the first cell list includes a cell corresponding to the first network device and/or a cell corresponding to the second network device; a SIB includes the first information and one or more synchronization signal block SSB identifiers, the first information indicates a communication mode of a network device corresponding to the one or more SSB identifiers, and the network device corresponding to the one or more SSB identifiers includes the first network device and/or the second network device; or a SIB includes the first information and one or more area identifiers, the first information indicates a communication mode of a network device in one or more areas indicated by the one or more area identifiers, and the network device in the one or more areas indicated by the one or more area identifiers includes the first network device and/or the second network device.

In a possible implementation, the first indication information indicates the mode of communication between the first network device and the terminal device, where the first information includes at least one of the following: indication information indicating that uplink configuration information between the terminal device and the first network device remains unchanged; information about association between an uplink data radio bearer DRB and a downlink DRB of the terminal device; encrypted information of downlink transmission between the terminal device and the first network device; or indication information indicating the communication mode of the first network device.

In a possible implementation, the first indication information indicates the mode of communication between the first network device and the terminal device; and that the processing unit 901 is configured to obtain the first indication information includes: The processing unit 901 is configured to receive the first indication information by using the transceiver unit 902.

In a possible implementation, the processing unit 901 is further configured to update the communication mode of the first network device based on the first indication information.

In a possible implementation, the first indication information indicates the mode of communication between the second network device and the terminal device; and that the processing unit 901 is configured to obtain the first indication information includes: The processing unit 901 is configured to determine the first indication information. The apparatus 900 further includes a transceiver unit 902, and the transceiver unit 902 is configured to send the first indication information to the second network device.

In a possible implementation, the first indication information is included in any one of the following: a radio access network RAN node configuration update message, a disable request reply message, a disable request reject message, or a cell activation request message.

It should be noted that, for content such as an information execution process of the units in the communication apparatus 900, refer to the descriptions in the foregoing method embodiment of this application. Details are not described herein again.

FIG. 10 is a diagram of another structure of a communication apparatus 1000 according to this application. The communication apparatus 1000 includes at least an input/output interface 1002. The communication apparatus 1000 may be a chip or an integrated circuit.

Optionally, the communication apparatus further includes a logic circuit 1001.

The processing unit 901 and the transceiver unit 902 shown in FIG. 9 may be communication interfaces. The communication interface may be the input/output interface 1002 in FIG. 10, and the input/output interface 1002 may include an input interface and an output interface. Alternatively, the communication interface may be a transceiver circuit, and the transceiver circuit may include an input interface circuit and an output interface circuit.

Optionally, the input/output interface 1002 is configured to obtain first information, where the first information is associated with a mode of communication between a first network device and the terminal device and/or a mode of communication between a second network device and the terminal device, and the communication mode includes any one of the following: whether uplink transmission is activated, or whether downlink transmission is activated; and the logic circuit 1001 is configured to communicate with the first network device and/or the second network device based on the first information. The logic circuit 1001 and the input/output interface 1002 may further perform other steps performed by the terminal device in any one of the foregoing embodiments, and implement corresponding beneficial effects. Details are not described herein again.

Optionally, the logic circuit 1001 is configured to obtain first indication information, where the first indication information indicates a mode of communication between the first network device and a terminal device and/or a mode of communication between a second network device and the terminal device, and the communication mode includes any one of the following: whether uplink transmission is activated, or whether downlink transmission is activated; and the logic circuit 1001 is further configured to determine the communication mode based on the first indication information. The logic circuit 1001 and the input/output interface 1002 may further perform other steps performed by the first network device in any one of the foregoing embodiments, and implement corresponding beneficial effects. Details are not described herein again.

In a possible implementation, the processing unit 901 in the communication apparatus 900 shown in FIG. 9 (or the processing unit 801 in the communication apparatus 800 shown in FIG. 8) may be the logic circuit 1001 in FIG. 10.

Optionally, the logic circuit 1001 may be a processing apparatus, and some or all functions of the processing apparatus may be implemented by using software. Some or all functions of the processing apparatus may be implemented by using software.

Optionally, the processing apparatus may include a memory and a processor. The memory is configured to store a computer program, and the processor reads and executes the computer program stored in the memory, to perform corresponding processing and/or steps in any method embodiment.

Optionally, the processing apparatus may include only a processor. A memory configured to store a computer program is located outside the processing apparatus, and the processor is connected to the memory through a circuit/wire, to read and execute the computer program stored in the memory. The memory and the processor may be integrated together, or may be physically independent of each other.

Optionally, the processing apparatus may be one or more chips or one or more integrated circuits. For example, the processing apparatus may be one or more field-programmable gate arrays (field-programmable gate array, FPGA), application-specific integrated circuits (application-specific integrated circuit, ASIC), system on chips (system on chip, SoC), central processing units (central processing unit, CPU), network processors (network processor, NP), digital signal processors (digital signal processor, DSP), micro controller units (micro controller unit, MCU), programmable controllers (programmable logic device, PLD), or another integrated chip, or any combination of the foregoing chips or processors.

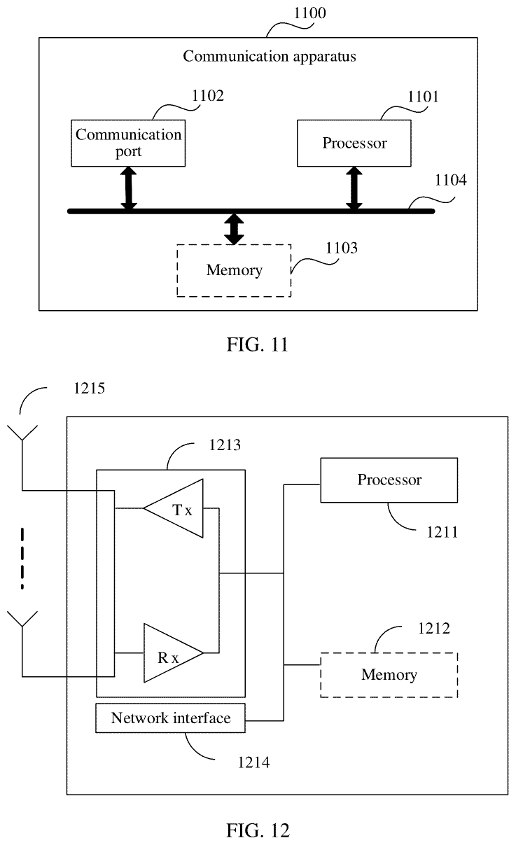

FIG. 11 shows a communication apparatus 1100 in the foregoing embodiment according to an embodiment of this application. The communication apparatus 1100 may be specifically a communication apparatus serving as the terminal device in the foregoing embodiment. An example shown in FIG. 11 is that the terminal device is implemented as the terminal device (or a component in the terminal device).

In a possible diagram of a logical structure of the communication apparatus 1100, the communication apparatus 1100 may include but is not limited to at least one processor 1101 and a communication port 1102.

Optionally, the apparatus may further include at least one of a memory 1103 and a bus 1104. In this embodiment of this application, the at least one processor 1101 is configured to control an action of the communication apparatus 1100.

In addition, the processor 1101 may be a central processing unit, a general-purpose processor, a digital signal processor, an application-specific integrated circuit, a field-programmable gate array or another programmable logic device, a transistor logic device, a hardware component, or any combination thereof. The processor may implement or execute various example logical blocks, modules, and circuits described with reference to content disclosed in this application. Alternatively, the processor may be a combination of processors implementing a computing function, for example, a combination including one or more microprocessors, or a combination of a digital signal processor and a microprocessor. It may be clearly understood by a person skilled in the art that, for the purpose of convenient and brief description, for a detailed working process of the foregoing system, apparatus, and unit, refer to a corresponding process in the foregoing method embodiment. Details are not described herein again.

It should be noted that the communication apparatus 1100 shown in FIG. 11 may be specifically configured to implement steps implemented by the terminal device in the foregoing method embodiment, and implement technical effects corresponding to the terminal device. For specific implementations of the communication apparatus shown in FIG. 11, refer to the descriptions in the foregoing method embodiment. Details are not described herein again.

FIG. 12 is a diagram of a structure of a communication apparatus 1200 in the foregoing embodiment according to an embodiment of this application. The communication apparatus 1200 may be specifically a communication apparatus serving as the first network device in the foregoing embodiment. For a structure of the communication apparatus, refer to the structure shown in FIG. 12.

The communication apparatus 1200 includes at least one processor 1211 and at least one network interface 1214. Optionally, the communication apparatus further includes at least one memory 1212, at least one transceiver 1213, and one or more antennas 1215. The processor 1211, the memory 1212, the transceiver 1213, and the network interface 1214 are connected, for example, through a bus. In this embodiment of this application, the connection may include various interfaces, transmission lines, buses, or the like. This is not limited in this embodiment. The antenna 1215 is connected to the transceiver 1213. The network interface 1214 is configured to enable the communication apparatus to communicate with another communication device through a communication link. For example, the network interface 1214 may include a network interface between the communication apparatus and a core network device, for example, an S1 interface. The network interface may include a network interface between the communication apparatus and another communication apparatus (for example, another network device or the core network device), for example, an X2 or Xn interface.

The processor 1211 is mainly configured to process a communication protocol and communication data, control the entire communication apparatus, execute a software program, and process data of the software program. For example, the processor 1211 is configured to support the communication apparatus in performing actions described in embodiments. The communication apparatus may include a baseband processor and a central processing unit. The baseband processor is mainly configured to process a communication protocol and communication data. The central processing unit is mainly configured to control the entire terminal device, execute a software program, and process data of the software program. Functions of the baseband processor and the central processing unit may be integrated into the processor 1211 in FIG. 12. A person skilled in the art may understand that the baseband processor and the central processing unit may alternatively be processors independent of each other, and are interconnected by using a technology such as a bus. A person skilled in the art may understand that the terminal device may include a plurality of baseband processors to adapt to different network standards, the terminal device may include a plurality of central processing units to enhance a processing capability of the terminal device, and components of the terminal device may be connected through various buses. The baseband processor may alternatively be expressed as a baseband processing circuit or a baseband processing chip. The central processing unit may alternatively be expressed as a central processing circuit or a central processing chip. The function of processing the communication protocol and the communication data may be built in the processor, or may be stored in the memory in a form of a software program, and the processor executes the software program to implement a baseband processing function.

The memory is mainly configured to store a software program and data. The memory 1212 may exist independently, and is connected to the processor 1211. Optionally, the memory 1212 and the processor 1211 may be integrated, for example, integrated into one chip. The memory 1212 may store program code for executing the technical solutions in embodiments of this application, and the processor 1211 controls execution of the program code. Various types of computer program code that are executed may also be considered as drivers of the processor 1211.

FIG. 12 shows only one memory and one processor. In an actual terminal device, there may be a plurality of processors and a plurality of memories. The memory may also be referred to as a storage medium, a storage device, or the like. The memory may be a storage element located on a same chip as the processor, namely, an on-chip storage element, or may be an independent storage element. This is not limited in this embodiment of this application.

The transceiver 1213 may be configured to support receiving or sending of a radio frequency signal between the communication apparatus and a terminal, and the transceiver 1213 may be connected to the antenna 1215. The transceiver 1213 includes a transmitter Tx and a receiver Rx. Specifically, the one or more antennas 1215 may receive a radio frequency signal. The receiver Rx of the transceiver 1213 is configured to receive the radio frequency signal from the antenna, convert the radio frequency signal into a digital baseband signal or a digital intermediate frequency signal, and provide the digital baseband signal or the digital intermediate frequency signal for the processor 1211, so that the processor 1211 performs further processing on the digital baseband signal or the digital intermediate frequency signal, for example, performs demodulation processing and decoding processing. In addition, the transmitter Tx of the transceiver 1213 is further configured to: receive a modulated digital baseband signal or digital intermediate frequency signal from the processor 1211, convert the modulated digital baseband signal or digital intermediate frequency signal into a radio frequency signal, and send the radio frequency signal through the one or more antennas 1215.

The transceiver 1213 may also be referred to as a transceiver unit, a transceiver, a transceiver apparatus, or the like. Optionally, a component that is configured to implement a receiving function and that is in the transceiver unit may be considered as a receiving unit, and a component that is configured to implement a sending function and that is in the transceiver unit may be considered as a sending unit. In other words, the transceiver unit includes the receiving unit and the sending unit. The receiving unit may also be referred to as a receiver, an input port, a receiving circuit, or the like. The sending unit may be referred to as a transmitter, a transmitting machine, a transmitting circuit, or the like.

It should be noted that the communication apparatus 1200 shown in FIG. 12 may be specifically configured to implement steps implemented by the network device in the foregoing method embodiment, and implement technical effects corresponding to the network device. For specific implementations of the communication apparatus 1200 shown in FIG. 12, refer to the descriptions in the foregoing method embodiment. Details are not described herein again.

An embodiment of this application further provides a computer-readable storage medium storing one or more computer-executable instructions. When the computer-executable instructions are executed by a processor, the processor performs the method according to the possible implementations of the terminal device in the foregoing embodiment.

An embodiment of this application further provides a computer-readable storage medium storing one or more computer-executable instructions. When the computer-executable instructions are executed by a processor, the processor performs the method according to the possible implementations of the first network device in the foregoing embodiment.

An embodiment of this application further provides a computer program product (or referred to as a computer program) storing one or more computer-executable instructions. When the computer program product is executed by a processor, the processor performs the method according to the possible implementations of the terminal device.

An embodiment of this application further provides a computer program product storing one or more computer-executable instructions. When the computer program product is executed by a processor, the processor performs the method according to the possible implementations of the first network device.

An embodiment of this application further provides a chip system. The chip system includes at least one processor, configured to support a communication apparatus in implementing functions in the possible implementations of the communication apparatus. Optionally, the chip system further includes an interface circuit, and the interface circuit provides program instructions and/or data for the at least one processor. In a possible design, the chip system may further include a memory. The memory is configured to store program instructions and data that are necessary for the communication apparatus. The chip system may include a chip, or may include a chip and another discrete component. The communication apparatus may be specifically the terminal device in the foregoing method embodiment.

An embodiment of this application further provides a chip system. The chip system includes at least one processor, configured to support a communication apparatus in implementing functions in the possible implementations of the communication apparatus. Optionally, the chip system further includes an interface circuit, and the interface circuit provides program instructions and/or data for the at least one processor. In a possible design, the chip system may further include a memory. The memory is configured to store program instructions and data that are necessary for the communication apparatus. The chip system may include a chip, or may include a chip and another discrete component. The communication apparatus may be specifically the first network device in the foregoing method embodiment.

An embodiment of this application further provides a communication system. The communication system includes the terminal device and the first network device in any one of the foregoing embodiments.

In several embodiments provided in this application, it should be understood that the disclosed system, apparatus, and method may be implemented in other manners. For example, the described apparatus embodiment is merely an example. For example, division into the units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, that is, may be located in one place, or may be distributed on a plurality of network units. Some or all of the units may be selected based on actual requirements to achieve the objectives of the solutions of embodiments.

In addition, function units in embodiments of this application may be integrated into one processing unit, or each of the units may exist alone physically, or two or more units are integrated into one unit. The integrated unit may be implemented in a form of hardware, or may be implemented in a form of a software functional unit. When the integrated unit is implemented in the form of a software functional unit and sold or used as an independent product, the unit may be stored in a computer-readable storage medium. The foregoing storage medium includes any medium that can store program code, such as a USB flash drive, a removable hard disk, a read-only memory (ROM, Read-Only Memory), a random access memory (RAM, Random Access Memory), a magnetic disk, or an optical disc.

1. A method, applied to a terminal device, comprising:
obtaining first information, wherein the first information is associated with a mode of communication between a first network device and the terminal device and/or a mode of communication between a second network device and the terminal device, and the communication mode comprises any one of the following:
whether uplink transmission is activated, or whether downlink transmission is activated; and
communicating with the first network device and/or the second network device based on the first information.

2. The method according to claim 1, wherein the communication mode comprises at least one of the following:
uplink transmission is activated and downlink transmission is deactivated, uplink transmission is deactivated and downlink transmission is activated, uplink transmission is activated, uplink transmission is deactivated, downlink transmission is activated, downlink transmission is deactivated, uplink transmission is activated and downlink transmission is activated, or uplink transmission is deactivated and downlink transmission is deactivated.

3. The method according to claim 1, wherein the first information is comprised in any one of the following:
a radio resource control (RRC) reconfiguration message or an RRC release message.

4. The method according to claim 1, wherein
the first information indicates a communication mode corresponding to one or more cells, and the one or more cells comprise a cell of the first network device and/or a cell of the second network device;
the first information indicates a communication mode of a network device corresponding to one or more synchronization signal block SSB identifiers, and the network device corresponding to the one or more SSB identifiers comprises the first network device and/or the second network device; or
the first information indicates a communication mode of a network device in one or more areas corresponding to one or more area identifiers, and the network device in the one or more areas corresponding to the one or more area identifiers comprises the first network device and/or the second network device.

5. The method according to claim 1, wherein the first information is associated with the mode of communication between the first network device and the terminal device, wherein
the first information comprises at least one of the following:
indication information indicating that uplink configuration information corresponding to uplink transmission between the terminal device and the first network device remains unchanged;
information about association between an uplink data radio bearer DRB and a downlink DRB of the terminal device;
encrypted information of downlink transmission between the terminal device and the first network device; or
indication information indicating the communication mode of the first network device.

6. A method, applied to a first network device, comprising:
obtaining first indication information, wherein the first indication information indicates a mode of communication between the first network device and a terminal device and/or a mode of communication between a second network device and the terminal device, and the communication mode comprises any one of the following:
whether uplink transmission is activated, or whether downlink transmission is activated; and
determining the communication mode based on the first indication information.

7. The method according to claim 6, wherein the communication mode comprises at least one of the following:
uplink transmission is activated and downlink transmission is deactivated, uplink transmission is deactivated and downlink transmission is activated, uplink transmission is activated, uplink transmission is deactivated, downlink transmission is activated, downlink transmission is deactivated, uplink transmission is activated and downlink transmission is activated, or uplink transmission is deactivated and downlink transmission is deactivated.

8. The method according to claim 6, wherein the method further comprises:
sending first information, wherein the first information is associated with the communication mode.

9. The method according to claim 8, wherein
the first information indicates a communication mode corresponding to one or more cells, and the one or more cells comprise a cell of the first network device and/or a cell of the second network device;
the first information indicates a communication mode of a network device corresponding to one or more SSB identifiers, and the network device corresponding to the one or more SSB identifiers comprises the first network device and/or the second network device; or
the first information indicates a communication mode of a network device in one or more areas corresponding to one or more area identifiers, and the network device in the one or more areas corresponding to the one or more area identifiers comprises the first network device and/or the second network device.

10. The method according to claim 8, wherein the first indication information indicates the mode of communication between the first network device and the terminal device, wherein
the first information comprises at least one of the following:
indication information indicating that uplink configuration information between the terminal device and the first network device remains unchanged;
information about association between an uplink data radio bearer DRB and a downlink DRB of the terminal device;
encrypted information of downlink transmission between the terminal device and the first network device; or
indication information indicating the communication mode of the first network device.

11. A communication apparatus, comprising a processor coupled to a memory storing computer-executable instructions, which when executed by the processor, cause the communication apparatus to:
obtain first information, wherein the first information is associated with a mode of communication between a first network device and the communication apparatus and/or a mode of communication between a second network device and the communication apparatus, and the communication mode comprises any one of the following:
whether uplink transmission is activated, or whether downlink transmission is activated; and
communicate with the first network device and/or the second network device based on the first information.

12. The communication apparatus according to claim 11, wherein the communication mode comprises at least one of the following:
uplink transmission is activated and downlink transmission is deactivated, uplink transmission is deactivated and downlink transmission is activated, uplink transmission is activated, uplink transmission is deactivated, downlink transmission is activated, downlink transmission is deactivated, uplink transmission is activated and downlink transmission is activated, or uplink transmission is deactivated and downlink transmission is deactivated.

13. The communication apparatus according to claim 11, wherein the first information is comprised in any one of the following:
a radio resource control (RRC) reconfiguration message or an RRC release message.

14. The communication apparatus according to claim 11, wherein
the first information indicates a communication mode corresponding to one or more cells, and the one or more cells comprise a cell of the first network device and/or a cell of the second network device;
the first information indicates a communication mode of a network device corresponding to one or more synchronization signal block SSB identifiers, and the network device corresponding to the one or more SSB identifiers comprises the first network device and/or the second network device; or
the first information indicates a communication mode of a network device in one or more areas corresponding to one or more area identifiers, and the network device in the one or more areas corresponding to the one or more area identifiers comprises the first network device and/or the second network device.

15. The communication apparatus according to claim 11, wherein the first information is associated with the mode of communication between the first network device and the communication apparatus, wherein
the first information comprises at least one of the following:
indication information indicating that uplink configuration information corresponding to uplink transmission between the communication apparatus and the first network device remains unchanged;
information about association between an uplink data radio bearer DRB and a downlink DRB of the communication apparatus;
encrypted information of downlink transmission between the communication apparatus and the first network device; or
indication information indicating the communication mode of the first network device.

16. A communication apparatus, comprising a processor coupled to a memory storing computer-executable instructions, which when executed by the processor, cause the communication apparatus to:
obtain first indication information, wherein the first indication information indicates a mode of communication between the communication apparatus and a terminal device and/or a mode of communication between a second network device and the terminal device, and the communication mode comprises any one of the following:
whether uplink transmission is activated, or whether downlink transmission is activated; and
determine the communication mode based on the first indication information.

17. The communication apparatus according to claim 16, wherein the communication mode comprises at least one of the following:
uplink transmission is activated and downlink transmission is deactivated, uplink transmission is deactivated and downlink transmission is activated, uplink transmission is activated, uplink transmission is deactivated, downlink transmission is activated, downlink transmission is deactivated, uplink transmission is activated and downlink transmission is activated, or uplink transmission is deactivated and downlink transmission is deactivated.

18. The communication apparatus according to claim 16, wherein when the instructions are executed by the processor, further cause the communication apparatus to:
sending first information, wherein the first information is associated with the communication mode.

19. The communication apparatus according to claim 18, wherein
the first information indicates a communication mode corresponding to one or more cells, and the one or more cells comprise a cell of the communication apparatus and/or a cell of the second network device;
the first information indicates a communication mode of a network device corresponding to one or more SSB identifiers, and the network device corresponding to the one or more SSB identifiers comprises the communication apparatus and/or the second network device; or
the first information indicates a communication mode of a network device in one or more areas corresponding to one or more area identifiers, and the network device in the one or more areas corresponding to the one or more area identifiers comprises the communication apparatus and/or the second network device.

20. The communication apparatus according to claim 18, wherein the first indication information indicates the mode of communication between the communication apparatus and the terminal device, wherein
the first information comprises at least one of the following:
indication information indicating that uplink configuration information between the terminal device and the communication apparatus remains unchanged;
information about association between an uplink data radio bearer DRB and a downlink DRB of the terminal device;
encrypted information of downlink transmission between the terminal device and the communication apparatus; or
indication information indicating the communication mode of the communication apparatus.
